(19) United States
(12) Patent Application Publication
(10) Pub. No.: US 2017/0081807 A1
(43) Pub. Date: Mar. 23, 2017

(54) POURED IN PLACE SURFACE COOLING TECHNOLOGY

(71) Applicant: Christopher Tetrault, Amelia, OH (US)

(72) Inventor: Christopher Tetrault, Amelia, OH (US)

(21) Appl. No.: 14/861,291

(22) Filed: Sep. 22, 2015

(51) Int. Cl. E01C 13/06; B05D 5/04; C09D 121/00; B05D 7/06; C09D 175/04; B05D 1/30; B05D 7/02

(52) U.S. Cl. CPC E01C 13/065; B05D 1/30; B05D 5/04; B05D 7/02; B05D 7/06; C09D 175/04; C09D 121/00

(57) ABSTRACT

The present invention provides for synthetic PIP surfacing materials surfacing materials and methods of making such materials wherein the surfaces of the materials have been modified with hydrophilic properties. The present invention also includes surfacing materials wherein a coating material is included with the surfacing to substantially modify the surfacing material with water retention or hydrophilic properties

### BACKGROUND OF THE INVENTION

1. Field of the Invention

The present invention relates to a method and of cooling synthetic surfaces by modifying the surface tension or contact angle of the surface of the materials in order to enable wetting out of those materials as well as enabling capillary action within the materials. The present invention also relates generally to a surfacing for playgrounds and the like, and a method for forming same on site.

2. Description of the Related Art

It is known that the poured in place (PIP) synthetic surfacing product has been used extensively in playgrounds, tracks, roofs, patios and many other surfaces where a durable resilient and shock absorbing surface is desirable. Presently, finished synthetic surface products are produced from recycled rubber are made by either vulcanizing the rubber or by making composites using ground rubber and polyurethane binders. EPDM rubber specifically manufactured for this use can also be used and is the most common type of rubber used in PIP systems.

In the polyurethane binder process, a mixture of ground rubber (crumb rubber) and one or more polyurethane binders is molded or formed and cured. The binder may be cured in a “hot-cure” process, at elevated temperatures, or in a “cold-cure” process, at ambient temperature and at ambient or low pressures. Cold-cure processes are typically used when the mixture is cured on-site, for example, for playground surfacing, running tracks, and floors for animal stalls.

An example of the use of a cold-cure process is U.S. Pat. No. 6,896,964 (Kvesic) which describes a method for fabricating a playground surfacing in which a mold is formed at the installation site and a filler material is poured into the mold (the entire disclosure of which is incorporated herein by reference). The filler material may be concrete, asphalt, landscape cloth, crumb rubber, stone, sand, metal, a polymer membrane, or a combination thereof. A rubber composite mixture including treated rubber and a binder, which may be a urethane binder, is mixed and placed over the filler material. This rubber-containing layer is then finished, e.g., smoothed, and allowed to cure or set. Once this layer sets, a second layer may be formed. The color of each layer may be selected as desired, e.g., the second layer may be colored whereas the first is not colored. Typically, there is a sub-base comprised of larger pieces of rubber than those in the top/finish layer, which are referred to as buffings.

Additional prior art that describes various ways to form support mats includes U.S. Pat. No. 3,446,122 (Raichle et al.) and U.S. Pat. No. 4,564,310 (Thelen et al.), the entire disclosure of each of which is disclosed herein by reference.

While the poured in place material has received great market acceptance for its desirable characteristics there is an extremely problematic and potentially dangerous aspect of the product. The material gets extremely hot when exposed to the suns radiation, dangerously so and can reach surface temperatures of 190 F or more. The fact that the surfaces are often used for children's play areas increase the danger of injury by causing skin burns and or heat exhaustion.

Recent news stories show cases of a child receiving severe burns from a poured in place play surface. This is all too common of an occurrence with hundreds of cases being reported annually. Obviously as is often the case with this type of incident statistically it is reasonable to assume that many more cases go unreported.

As well as causing injury to people the impact of hot built surfaces contribute to the “Urban Heat Island Effect” as well as generally causing the environment to get out of balance as far as the overall earths ‘Energy Budget” is concerned. Specifically, there have been many reported cases of children receiving severe burns when their skin comes in contact with the PIP systems.

It would be desirable to provide an improved unitary surfacing for playgrounds and the like, and method for forming a unitary surfacing for playgrounds and the like on site and using a cold-cure process. What is needed is a means of sustaining evaporative cooling of synthetic play surfaces during athletic activity and anytime there is strong radiant solar heat present in order to provide safety to users and reduce the impact the urban heat island.

### SUMMARY OF THE INVENTION

The present invention provides new and improved poured in place surfacing and method for forming a poured in place surfacing on site. Such a method is also referred to as a “poured in place” or PIP method.

In one embodiment of a method for manufacturing a poured in place surfacing on site in accordance with the invention includes placing loose fill material into a defined area in which the surfacing is to be formed, mixing rubber particles with at least one binder to form a mixture, placing the mixture over the loose fill material, trowelling or otherwise shaping and finishing to desirable surface topography and allowing the mixture to dry whereby the dried mixture in combination with the loose fill material forms the poured in place surfacing.

The various exemplary embodiments of the present invention include new and improved poured in place surfacing and method for forming a poured in place surfacing on site wherein a coating material is included with the surfacing to substantially modify the surfacing material with water retention or hydrophilic properties.

In one embodiment, the loose fill material includes only rubber particles, without a binder. The mixture placed over these loose rubber particles seals and contains the loose rubber particles. In another embodiment, the loose fill material includes a binder.

In another embodiment, the poured in place surfacing and method for forming a poured in place surfacing on site are provided wherein surfactant alone is introduced creates a hydrophilic effect on the surface of the rubber enabling moisture retention and evaporative cooling.

In one embodiment, the poured in place surfacing and method for forming a poured in place surfacing on site are provided wherein a coating material is a topically applied surface treatment agents (surfactants), that is applied to surfacing and works its way through porous cured poured in place rubber system. In one embodiment, the solution cures in situ at ambient temperatures.

In another embodiment, the poured in place surfacing and method for forming a poured in place surfacing on site are provided wherein a coating material is a topically applied aqueous super absorbent polymer (SAP) that is applied to surfacing and works its way through porous cured poured in place rubber system. In one embodiment, the solution cures in situ at ambient temperatures. The porosity of the system creates pockets that enhance the ability to add a significant amount of aqueous super absorbent polymer (SAP) without making the system too soft or spongy. This is due to the fact that the rubber particles that are adhered to each other as a whole form the structure and lend the dimensional stability to the system.

In another embodiment, the poured in place surfacing and method for forming a poured in place surfacing on site are provided wherein a coating material is a topically applied combination of surfactant and aqueous super absorbent polymer (SAP) that is applied to surfacing and works its way through porous cured poured in place rubber system. In one embodiment, the solution cures in situ at ambient temperatures. The porosity of the system creates pockets that enhance the ability to add a significant amount of aqueous super absorbent polymer without making the system too soft or spongy. This is due to the fact that the rubber particles that are adhered to each other as a whole form the structure and lend the dimensional stability to the system.

In another embodiment, the poured in place surfacing and method for forming a poured in place surfacing on site are provided wherein a surface treatment agent (surfactant), is blended with binder (such as polyurethane) before or after being mixed with rubber particles forming a flowable/moldable/extrudable rubber material that can be poured in place. The surfacing may then be trowelled to a desired surface finish. The combined surfactant, binder and rubber material cures rapidly in place. The resulting substrate is extremely resilient and has the added benefit of being hydrophilic due to the surfactant that becomes part of the system.

In another embodiment, a super absorbent polymer (SAP) particulate is introduced into the poured in place surfacing. The super absorbent polymer (SAP) particulate is generally a ground super absorbent polymer (SAP).

In one embodiment, the super absorbent polymer (SAP) particulate is mixed into the poured in place surfacing material and then formed into the finished surfacing. In another embodiment, the super absorbent polymer (SAP) particulate is introduced into the poured in place surfacing after the surfacing is in place. The super absorbent polymer (SAP) particulate may be mixed with an aqueous solution, a solution of super absorbent polymer (SAP), surfactant or both and then aqueous solution can be added to the poured in place surfacing via the surface. The particulate can be directly added to the surfactant, aqueous SAP, or with sodium in it to temporarily retard swelling of the SAP particulate.

In another embodiment, the poured in place surfacing and method for forming a poured in place surfacing on site are provided wherein an aqueous absorbent polymer (SAP) is blended with a binder (such as polyurethane) before or after being mixed with rubber particles forming a flowable/moldable/extrudable rubber material that can be poured in place. The surfacing may then be trowelled to a desired surface finish. The combined aqueous SAP, binder and rubber material cures rapidly in place. The resulting substrate is extremely resilient and has the added benefit of being hydrophilic due to the SAP that becomes part of the binder component of the system.

In another embodiment, the poured in place surfacing and method for forming a poured in place surfacing on site are provided wherein an aqueous super absorbent polymer (SAP) and a surfactant are blended with a binder (such as polyurethane) before or after being mixed with rubber particles forming a flowable/moldable/extrudable rubber material that can be poured in place. The surfacing may then be trowelled to a desired surface finish. The combined aqueous SAP, surfactant, binder and rubber material cures rapidly in place. The resulting substrate is extremely resilient and has the added benefit of being hydrophilic due to the SAP that becomes part of the binder component of the system.

In another embodiment, the poured in place surfacing and method for forming a poured in place surfacing on site are provided wherein a particulate super absorbent polymer (SAP) and a surfactant are blended with a binder (such as polyurethane) before or after being mixed with rubber particles forming a flowable/moldable/extrudable rubber material that can be poured in place. The surfacing may then be trowelled to a desired surface finish. The combined aqueous SAP, surfactant, binder and rubber material cures rapidly in place. The resulting substrate is extremely resilient and has the added benefit of being hydrophilic due to the SAP, which becomes part of the binder component of the system.

In another embodiment, the poured in place surfacing and method for forming a poured in place surfacing on site are provided wherein surfactant is introduced creates a hydrophilic effect on the surface of the rubber enabling moisture retention and evaporative cooling.

In another embodiment, the invention relates, generally, to multi-layered systems for protection for humans and even animals from injury from falling on hard, unforgiving surfaces, and more particularly, to systems which have a special purpose of protection for children falling out of playground equipment onto compacted dirt, cement or the like, and, even grass, which would otherwise cause serious, even fatal injuries to such children: and also relates to methods for manufacturing and installing such systems on the surface below where such playground equipment will be used.

In another embodiment, the poured in place surfacing and method for forming a poured in place surfacing on site are provided wherein surfactant is introduced in combination with one or more surface treatment agents (surfactants), which create a hydrophilic effect on the surface of the rubber enabling moisture retention and evaporative cooling.

In additional particular embodiments in which there are two or more surface treatment agents, one or more optionally chemically immobilized onto the surface of a pigment.

In another embodiment, additional surface-treatment agents may also be added. For example, more than one hydrophilic surface treatment agent and more than one hydrophobic surface treatment agent may be used. Additional surface treatment agents can be adhered to the surfacing to impart additional functionality of these surface treatment agents.

The mixture may incorporate color, e.g., by adding a colorant to the mixture and/or using colored rubber particles. Alternatively or additionally, a colored mixture may be prepared and placed over the dried mixture.

One embodiment of a poured in place surfacing in accordance with the invention would therefore include a base layer of only loose rubber particles without a binder, and a rubber layer including rubber particles and at least one binder which has reacted with the rubber to form a poured in place surfacing when dried, in combination with the loose rubber particles. The rubber layer seals and contains the base layer to thereby prevent shifting and movement of the loose rubber particles of the base layer.

The surfactant coating material can be one or more substances that will substantially modify the surface of the surfacing material. Examples are triethanolamine, propylene glycol, titanium dioxide and a variety of different flouro surfactants. Preferred surfactants are those that are biocompatible for use in aquatic weed control or in situations where some of the surfactant is likely to be introduce into ground water such as materials with trade names like Carbowet® 13-40, Cide Kick (d,1-limonene), Cygnet Plus (d,-limonene and related isomers), EnviroGem, Klucel, Plex Mate, Pluronics, SilEnergy (an organosilicone surfactant, polyalkyleneoxide modified polydimethyisloloxane and nonionic surfactants), Suretech 827 and 830, Triton. Surfactants included in the EPA “Safer Chemicals for Use in EPA's Design for the Environment-Labeled Products, Design for the Environment, U.S. EPA” are especially desirable for use with this invention.

The modification of surfaces with the materials described may be carried out, for example, by the methods known from the prior art, such as dip, spray or spin coating, flow coating, misting, brush application, rolling, printing, screen printing, stamping and—given a suitable consistency of the formulas of the invention that are used for surface modification—by powder coating methods as well.

The present invention therefore provides surfaces with hydrophilic properties, wherein the surfaces comprise particles with hydrophilic properties. The present invention also provides a process for producing surfaces with hydrophilic properties. The methods provide that activating the surface of the infill add little bulk if any to surfacing materials, providing more space for water film on the surfaces and pores of the materials.

The process of the invention and the surfaces of the invention are described by way of example below without any intention that the invention be restricted to these.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a flow chart of a method for forming a poured in place surfacing in accordance with the invention.

FIG. 2 is a cross-section of an embodiment of a poured in place play surfacing 20 in accordance with the invention wherein the impact layer 24 sits on top of a specified sub-base 26. Shown is an optional wear layer 22 on top.

FIG. 3 is a cross-section of an embodiment of a poured in place sports surfacing 30 in accordance with the invention wherein the base layer 32 sits on top of a specified sub-base 34. The impact layer and sub-base are shown on top of a suitable substrate base 36.

FIG. 4 is a cross-section of an embodiment of a poured in place flooring surfacing 40 in accordance with the invention wherein the base layer 42 sits on top of a flooring sub-base 44. The impact layer and flooring are shown on top of a suitable hard substrate base 46.

FIG. 5 is a cross-section of an embodiment of a poured in place surfacing 50 in accordance with the invention wherein the impact layer 54 sits on top of a specified sub-base. Shown is an optional wear layer 52 on top. The system sits on top of a compacted sub-base layer 56 that sits on top of a compacted second sub-base layer 58.

FIG. 6 is a cross-section of an embodiment of a poured in place surfacing system 60 in accordance with the invention wherein the impact layer 64 sits on top of a specified sub-base. Shown is an optional wear layer 62 on top. The system sits on top of either a hard sub-base layer 65 or a compacted aggregate sub-base layer 66 that sits on top of a compacted second sub-base layer 68. Optional geotextile 67 is shown placed between the first and second sub-base layers. Additionally, an optional border 63 is shown.

Before describing the present invention in detail, it is to be understood that this invention is not limited to particularly exemplified systems or process parameters as such may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated as incorporated by reference.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

### DEFINITIONS

As used in the present specification, the following words and phrases are generally intended to have the meanings as set forth below, except to the extent that the context in which they are used indicates otherwise.

“Polymer” as used herein, refers to a series of repeating monomeric units that have been cross-linked or polymerized. Any suitable polymer can be used to carry out the present invention. It is possible that the polymers of the invention may also comprise two, three, four or more different polymers. In some embodiments, of the invention only one polymer is used. In some preferred embodiments a combination of two polymers are used. Combinations of polymers can be in varying ratios, to provide polymer coatings with differing properties. Those of skill in the art of polymer chemistry will be familiar with the different properties of polymeric compounds. Examples of polymers that may be used in the present invention include, but are not limited to polycarboxylic acids, cellulosic polymers, proteins, polypeptides, polyvinylpyrrolidone, maleic anhydride polymers, polyamides, polyvinyl alcohols, polyethylene oxides, glycosaminoglycans, polysaccharides, polyesters, polyurethanes, polystyrenes, copolymers, silicones, polyorthoesters, polyanhydrides, copolymers of vinyl monomers, polycarbonates, polyethylenes, polypropylenes, polylactic acids, polyglycolic acids, polycaprolactones, polyhydroxybutyrate valerates, polyacrylamides, polyethers, polyurethane dispersions, polyacrylates, acrylic latex dispersions, polyacrylic acid, mixtures and copolymers thereof. The polymers of the present invention may be natural or synthetic in origin, including gelatin, chitosan, dextrin, cyclodextrin, poly(urethanes), Poly(siloxanes) or silicones, Poly(acrylates) such as poly(methyl methacrylate), poly(butyl methacrylate), and Poly(2-hydroxy ethyl methacrylate), Poly(vinyl alcohol) Poly(olefins) such as poly(ethylene), poly(isoprene), halogenated polymers such as Poly(tetrafluoroethylene)—and derivatives and copolymers such as those commonly sold as Teflon products, Poly(vinylidine fluoride), Poly(vinyl acetate), Poly(vinyl pyrrolidone), Poly(acrylic acid), Polyacrylamide, Poly(ethylene-co-vinyl acetate), Poly(ethylene glycol), Poly(propylene glycol), Poly(methacrylic acid); etc.

“Performance-enhancing active” or “performance-enhancing additive” as used herein, refers to any additive which is desirable to add to the surface treatments and polymers including an antimicrobial, an odor reducing material, a binder, a fragrance, a color altering agent, a dust reducing agent, a nonstick release agent, a cyclodextrin, zeolite, activated carbon, a pH altering agent, a salt forming material, a ricinoleate, silica gel, UV stabilizers or protectants, crystalline silica, activated alumina, an anti-clumping agent, and mixtures thereof. Performance-enhancing actives that inhibit the formation of odor include a water-soluble metal salt such as silver, copper, zinc, iron, and aluminum salts and mixtures thereof.

“Playground” describes an area either indoors or outdoors where people; especially but not solely children play; optionally using playground apparatus such as slides and swings. The term also covers areas where walking, games or physical exercises are carried out.

The term “superabsorbent materials” refers to water-swellable, water-insoluble organic or inorganic materials including superabsorbent polymers and superabsorbent polymer compositions capable, under the most favorable conditions, of absorbing at least about 1 times their weight, or at least about 5 times their weight, or at least about 10 times their weight in an aqueous solution. Superabsorbent materials include a “superabsorbent polymer” or “SAP”, a normally water-soluble polymer which has been cross-linked to render it substantially water insoluble, but capable of absorbing water. Numerous examples of superabsorbers and their methods of preparation may be found for example in U.S. Pat. Nos. 4,102,340; 4,467,012; 4,950,264; 5,147,343; 5,328,935; 5,338,766; 5,372,766; 5,849,816; 5,859,077; and U.S. Pat. No. Re. 32, 649.

The super absorbent polymers may be, for example, polymers or copolymers of partially neutralized acrylic acid, acrylamide, or acrylic esters as copolymer only. Preferably, the super absorbent polymer may swell in water or other introduced liquids up to about 200 to about 400 times its size. It is also preferred that the super absorbent polymers are nontoxic.

SAPs generally fall into three classes, namely starch graft copolymers, cross-linked carboxymethylcellulose derivatives and modified hydrophilic polyacrylates. Non-limiting examples of such absorbent polymers are hydrolyzed starch-acrylate graft co-polymer, saponified acrylic acid ester-vinyl co-polymer, neutralized cross-linked polyacrylic acid, cross-linked polyacrylate salt, and carboxylated cellulose. The preferred SAPs, upon absorbing fluids, form hydrogels. SAPs are well known and are commercially available from several sources.

“Water-absorbing material” as used herein includes, but is not limited to a hydrophilic polymer. “Water-absorbing material” as used herein includes, but is not limited to a highly absorbent material, which may comprises a superabsorbent polymer. Examples of water-vapor trapping materials include, but are not limited to, acrylate polymers, generally formed from acrylic acid, methacrylic acid, acrylate, methyl acrylate, ethyl acrylate, methyl methacrylate, ethyl methacrylate, a dialkylaminoalkyl acrylate, a dialkylaminoalkyl methacrylate, a trialkylammonioalkyl acrylate, and/or a trialkylammonioalkyl methacrylate, and include the polymers or copolymers of acrylic acid, methacrylic acid, methyl methacrylate, ethyl methacrylate, 2-dimethylaminoethyl methacrylate, and trimethylammonioethyl methacrylate chloride. Examples of hydrophilic polymers include, but is not limited to poly(N-vinyl lactams), poly(N-vinyl acrylamides), poly(N-alkylacrylamides), substituted and unsubstituted acrylic and methacrylic acid polymers, polyvinyl alcohol (PVA), polyvinylamine, copolymers thereof and copolymers with other types of hydrophilic monomers (e.g. vinyl acetate), polysaccharides, cross-linked acrylate polymers and copolymers, carbomers, cross-linked acrylamide-sodium acrylate copolymers, gelatin, vegetable polysaccharides, such as alginates, pectins, carrageenans, or xanthan, starch and starch derivatives, galactomannan and galactomannan derivatives. polyvinyl pyrrolidone (PVP), poly(N-vinyl caprolactam) (PVCap), poly(N-vinyl acetamides), polyacrylic acid, polymethacrylic acid, and copolymers and blends thereof. PVP and PVCap. Examples of superabsorbent polymers include hydrogels. Copolymers of any of the water-vapor trapping materials mentioned herein, and blends thereof may also be used.

The term “rubber” as used in relation to either rubber particles or rubber coated particles means any resilient elastomeric material, including natural and artificial rubbers, elastomers and polymers such as thermoplastic polymers and elastomers and equivalent materials.

As used herein, the term “surface-treatment agent” or “surface-modifying agent” refers to chemical agents that have the ability to modify, alter or react with the surface of a substrate by forming chemical bonds on the surface of the substrate. Specific non-limiting classes of surface treatment agents include surface-active agents, which include surfactants, detergents, wetting agents and emulsifiers. Surface-active agents may be nonionic, anionic, cationic, amphoterics, hydrophobic or hydrophilic.

“Substrate” as used herein, refers to any surface upon which it is desirable to deposit a synthetic PIP surfacing system. In the present invention, the substrate is generally made up of fine granules of stone, gravel, sand, asphalt, cement, ceramic beads, soil, clay, diatomaceous earth, perlite, silica, organic minerals, rubber or combinations thereof.

The term “% by weight” or “% wt” when used herein and referring to components of the composition, is to be interpreted as based on the weight of the composition, unless otherwise specified herein.

These terms may be defined with additional language in the remaining portions of the specification.

In one embodiment, the present invention relates to a method of cooling synthetic surfacing systems by coating the surfacing materials with a surface-modifying agent, a water absorbing material or a combination thereof in order to enable water retention within the surfacing for cooling.

In one embodiment, the present invention relates to a method of cooling synthetic surfacing systems by coating the surfacing materials with a water absorbing material comprising one or more superabsorbent polymer composition in order to enable water retention within the surfacing for cooling.

The surfacing is treated or coated with one or more water-absorbing material composition may be prepared by dipping, spraying, and/or coating an aqueous solution of a water-absorbing material. In one embodiment, the water-absorbing material comprises surface-treatment agents, superabsorbent materials or mixtures thereof. In one embodiment, the superabsorbent materials are one or more superabsorbent polymers. In one embodiment, the one or more superabsorbent polymers are formed from an acrylic monomer and cross-linking agent coated onto the surfacing material substrate.

In an exemplary embodiment, the superabsorbent polymer is created using an acrylic monomer solution is in the form of the partially neutralized acrylic acid. The partially neutralized acrylic acid is introduced in water to one or more cross-linking agents and/or UV-sensitive or peroxide reagents. A UV-light, heat or chemical initiator may be used to form the polymer as a cross-linked polymer without the cross-linking monomers, but the cross-linking agents assist in better controlling the level and degree of cross-linking and strength associated with cross-linked polymers.

Polymerization of the one or more monomers into super absorbent polymers may occur via exposure to heat, ultraviolet (UV) light radiation, peroxides, chemical initiator or other known polymerization process. UV-dependent photoinitiators of polymerization useful in exemplary embodiments of the present invention are water-soluble or water dispersible compounds that generate free radicals upon exposure to UV irradiation. Examples of such polymerization initiators include, 4-benzoyl-N, N-dimethyl-N-(2-(1-oxo-2-propenyloxy)ethyl) benzenemethananaminium bromide (available commercially as Quantacure ABQ) in combination with N-methyl-diethanolamine (NMDEA), and 2-hydroxy-2-methyl-1-phenyl-1-propanone (available commercially as Darocure 1173).

When the super absorbent polymers are contacted with water, the super absorbent polymers increase dramatically in size. Depending on the relative size and thickness, the super absorbent polymers may reach maximum moisture retention in as quickly as about ten minutes can reach maximum hydration in as little as ten minutes or as much as days. After reaching maximum moisture retention the retained moisture slowly releases from the super absorbent polymers depending on the particular conditions present, such as, for example, ambient temperature, sunlight, humidity, etc. Typically, the moisture evaporates from the super absorbent polymers and thereby keeps the surfacing cool.

Polymerization and cross-linking of the acrylic monomers and cross-linking agents to form super absorbent polymers within the surfacing significantly ensures limited movement of the resultant super absorbent polymers relative to the surfacing, thereby substantially maintaining within the associated poured in place (PIP) synthetic surfacing despite weather, traffic, water flow, and the like upon the surfacing. Maintaining the super absorbent polymers within the poured in place (PIP) synthetic surfacing decreases the need to have to reintroduce or resupply with cooling materials.

Cross-linking agents instrumental in propagating the polymerization and forming a branched network of polymers include, for example, N, N-methylene bis-acrylamide (NMBA), polyethylene glycol diacrylate (PEGDA) and polyethylene glycol dimethacrylate (PEGDMA).

In one embodiment, the super absorbent polymer composition is formed from (a) one or more water-soluble polymers; and (b) one or more cross-linking agents. In another embodiment, the one or more water-soluble polymers comprise polymerizable unsaturated monomers with one or more functional groups. In another embodiment, the one or more functional groups are acid functional groups. In another embodiment, from 5 to 30% of the acid groups on the one or more organic water-soluble polymers are crosslinked by the one or more crosslinking agents to form a superabsorbent polymer composition that is water-swellable and substantially water insoluble but capable of absorbing at least about 5 times the its weight in water of the composition of an aqueous solution. In another embodiment, the superabsorbent polymer composition forms a coating over the outer surface of the surfacing. In another embodiment, the one or more cross-linking agents are reagents selected from the group consisting of metal carbonates, UV-sensitive reagents and peroxides. In another embodiment, the one or more water-soluble polymer is selected from the group consisting of polycarboxylic acids, polypeptides, polyanhydrides, polylactic acids, polyglycolic acids, acrylic latex dispersions, polyacrylic acid, copolymers of acrylic acid with acrylamide, acrylic esters and/or vinyl monomers, and mixtures thereof.

A solution of a polymer, that is, for example, a non-cross-linked acrylic polymer, and a cross-linking agent may also be injected into one or more layers of an already-installed traditional poured in place (PIP) synthetic surfacing, such that the acrylic polymers are injected into and/or onto the surfacing immediately upon being admixed. The means of coating substances such as, for example, acrylic polymer solutions and cross-linking reagents is known in the art.

The various exemplary embodiments of the present invention further include a method of cooling a poured in place (PIP) synthetic surfacing, that is, for example, a traditional poured in place (PIP) synthetic surfacing that has already been installed. The poured in place (PIP) synthetic surfacing may be comprised of a substrate or foundation, wherein the foundation is selected from one or more of bare ground, loose fill, stone, gravel, sand, asphalt, cement, rubber, and construction materials; and one or more surfacing layers substantially adjacent to the topside of the foundation.

To define the area, the underlying ground surface may be worked as known to those skilled in the art. Alternatively, the ground surface does not have to be worked and may be left as is, e.g., ungraded, because the foundation, such as loose fill material, will naturally fill in any voids or depressions in the ground surface. The loose fill material constitutes a base layer and may include any material or combination of materials that meets the ASTM 1292 standard for impact attenuation. Examples of such materials include rubber mulch, wood chips, shredded tire rubber, pea gravel and loose foam. In a preferred embodiment, the loose fill material would include only recycled rubber particles without any binder.

The method includes the steps of introducing a solution of one or more non-cross-linked acrylic polymers and one or more cross-linking agents into or below the poured in place (PIP) synthetic surfacing; and cross-linking the acrylic polymer to form one or more superabsorbent polymers. The solution may be introduced via spraying or injecting, and then cross-linked once it is introduced to the desired location relative to the poured in place (PIP) synthetic surfacing.

In addition to introducing super absorbent polymers into one or more layers of a traditional surfacing, a solution of one or more non-cross-linked acrylic polymers and one or more cross-linking agents may be injected or introduced into a surfacing in this manner having a cooling material as set forth herein, in order to resupply, energize, and/or otherwise increase the water retention and cooling effect of the surfacing.

The life of the super absorbent polymers depends on various conditions, including, for example, adjacent soil conditions, microbes that feed on the super absorbent polymers, fungi, UV, foot traffic, weather conditions, and the like. Some super absorbent polymers may have a life of several years and have an estimated cost of less than about one third of a comparative amount of rubber granules.

The cooling material may be further comprised of at least one neutralizing material to assist in controlling moisture content and liquid absorbing capacities of the super absorbent polymers.

In various exemplary embodiments, the cooling material is bonded to the surfacing. The bonding may be by way of one or more adhesives, for example. The cooling material may also be attached to the backing layer via a mechanical means of stitching and/or stapling, for example, by way of the attached grass-like filaments and/or other thread. In other various exemplary embodiments, the cooling material and backing layer are adjacent but not chemically or mechanically attached.

In a preferred embodiment, even when the super absorbent polymers swell or expand to the greatest extend with water or other fluid, the cooling material still has channels or openings allowing water, air, moisture, or a combination thereof to flow through to the foundation and ground or evaporation through the poured in place (PIP) synthetic surfacing. Such channels or openings decrease pooling of water or fluids on the surface of the poured in place (PIP) synthetic surfacing as well.

The cooling material of exemplary embodiments herein is preferably of an open structure to allow some flow of liquids, air, moisture, or a combination thereof through the surfacing. Moisture evaporation will absorb much of the heat from the poured in place (PIP) synthetic surfacing. The cooling material substantially holds moisture in the polymer and slowly allows evaporation, substantially controlled by diffusion of moisture out of the polymer, cooling the poured in place (PIP) synthetic surfacing over time.

The poured in place (PIP) synthetic surfacing may further comprise an underground sprinkler system for applying water to the super absorbent polymers as needed, one or more thermal probes for determining the temperature of the synthetic tuft systems, or a combination thereof. The one or more thermal probes may be a thermocouple system in substantial contact with the poured in place (PIP) synthetic surfacing and would allow remote monitoring of the installation.

In one embodiment with poured in place (PIP) synthetic surfacing, an impact layer base is first prepared using a rubber-containing mixture. The rubber-containing mixture includes rubber particles and one or more binders which will bind the rubber. The rubber particles and binder(s) are placed into a mixer, which would likely be situated at or proximate the prepared site at which the surfacing is to be formed. The mixer may be similar to a portable cement mixer. Although rubber particles are preferred, any shock-absorbing material may be used in the invention. The rubber particles preferably have a granule size from about 0.5 mm to about 4 mm and/or may be thermoplastic vulcanized (TPV) granules. However larger or smaller sizes are acceptable. The rubber particles may be fine rubber crumbs, small rubber chunks, rubber slivers/buffing and combinations thereof. Further, the rubber particles may be recycled rubber particles. e.g., from used tires or other rubber products such as shredded recycled tires.

The binders may each be any binder known to those skilled in the art which interacts with rubber particles and binds the rubber particles into a cohesive unit, e.g., when the binder is exposed to air for a certain amount of time. An example of a common binder used in this field is polyurethane. Two other types of common binders are SBR and acrylic binders. SBR binders are often used to increase sealing performance with oils. SBR binders generally will cause a material to swell or expand when in contact with oils. This property provides increased sealing performance by allowing the material to seal potential leak paths in an application. SBR materials offer better sealing performance with less than ideal sealing flange surfaces, or between dissimilar sealing surfaces, such as a stamped-pan sealing against a cast surface area. H&V material grade names that begin with the letter “S” use an SBR binder system. Acrylic binders are similar to those used in paints.

In another embodiment with poured in place (PIP) synthetic surfacing, an impact layer base is first prepared using SBR rubber chunks and/or granules. Then, rubber granules, which are usually EPDM, are combined with polyurethane and mixed until granules are wetted out. The EPDM and polyurethane mixture is then troweled, brushed or graded into place. Finally, the PIP system is allowed to cures in situ to a hardened state. The poured in place (PIP) synthetic surfacing remains permeable and porous after installation. It is resilient and long lasting, however, as mentioned above it gets extremely hot when exposed to direct sunlight.

The follow chart lists the thickness of the SBR and EPDM required to achieve safe shock absorbing characteristics.

TABLE 1
SBR Base and EPDM Cap Thickness Requirements

| | | | | | | | | |
|---|---|---|---|---|---|---|---|---|
| Fall | 0 | 2 | 4 | 5 | 6 | 7 | 8 | 10 |
| Height | | | | | | | | |
| (feet) | | | | | | | | |
| Base | 0.00 | 1.00 | 1.25 | 1.50 | 2.00 | 2.50 | 3.00 | 4.00 |
| Thickness | | | | | | | | |
| (inches) | | | | | | | | |
| Base + | 0.50 | 1.50 | 1.75 | 2.00 | 2.50 | 3.00 | 3.50 | 4.5 |
| Cap | | | | | | | | |
| Thickness | | | | | | | | |
| (inches) | | | | | | | | |

The super absorbent polymers and/or the cooling material may further be treated with one or more antimicrobial agents, one or more anti-freezing agents, or a combination thereof.

In one embodiment, the SAP is manufactured using a cross-linked aqueous solution polymer composition consisting of about 15 wt-% to about 50 wt-% of at least one water-soluble monomer and a cross-linking agent as described in U.S. Pat. No. 7,438,951 by Anderson et al. and assigned to H.B. Fuller Licensing & Financing, Inc., incorporated herein in its entirety for all purposes.

In one embodiment, the superabsorbent polymer composition comprises one or more water-soluble polymers; and one or more cross-linking agents, wherein the one or more water-soluble polymers comprise polymerizable unsaturated monomers with one or more acid functional groups. In another embodiment, from 5 to 30% of the acid groups on the one or more water-soluble polymers are crosslinked by the one or more crosslinking agents to form a superabsorbent polymer composition that is water-swellable and substantially water insoluble but capable of absorbing at least about 5 times its weight in water.

In another embodiment, the one or more cross-linking agents are UV-sensitive reagents that are UV-dependent photoinitiators of polymerization. In another embodiment, the one or more cross-linking agents is a UV-dependent photoinitiator is selected from the group consisting of 4-benzoyl-N, N-dimethyl-N-(2-(1-oxo-2-propenyloxy)ethyl) benzenemethananaminium bromide in combination with N-methyl-diethanolamine, and 2-hydroxy-2-methyl-1-phenyl-1-propanone. In another embodiment, the one or more water-soluble polymer is selected from the group consisting of polycarboxylic acids, polypeptides, polyanhydrides, polylactic acids, polyglycolic acids, acrylic latex dispersions, polyacrylic acid, copolymers of acrylic acid with acrylamide, acrylic esters and/or vinyl monomers, and mixtures thereof.

In one embodiment, the at least one water-soluble monomer is an alpha, beta-ethylenically unsaturated carboxylic acid monomer. In one embodiment, the polymer solution is sufficiently low enough in viscosity such that it can be applied in aqueous form, yet after cross-linking possesses a fast rate of acquisition and is highly absorbent. In one embodiment, the aqueous polymer composition consists essentially of one or more water-soluble monomers, preferably at least one alpha, beta-ethylenically unsaturated carboxylic acid monomer and a cross-linking agent.

In one embodiment, the superabsorbent polymer composition of the present invention comprises an aqueous medium of 5 wt-% to about 65 wt-% solids of a polymer prepared by an aqueous solution polymerization of one or more water-soluble monomers. The preferred water-soluble monomers are alpha, beta-ethylenically unsaturated mono- or dicarboxylic acids and acid anhydrides, such as acrylic acid, methacrylic acid, crotonic acid, maleic acid/anhydride, itaconic acid, fumaric acid and the like with acrylic acid being the most preferred. The polymerization of such monomers produces an alkali soluble polyelectrolyte. Small amounts of other water-soluble monomers may be incorporated. Examples may include 2-hydroxyethyl acrylate, 2-hydroxyethyl methacrylate, vinyl pyrolidone, acrylamide, methacrylamide, sodium vinyl sulfonate, 1-allyloxy-2-hydroxypropane sulfonate, etc. The invention also contemplates the use of small amounts of water insoluble monomers provided the intended properties of the pre-cross-linked and/or post-cross-linked polymer are not adversely affected.

Any free radical generating source, such as peroxides and persulfates, may be used to initiate the polymerization of the monomers and carry out the polymerization well known to those skilled in the art. Further, chain transfer agents known in the art may be employed to alter the molecular weight.

In one embodiment, the aqueous composition of the carboxylic acid-containing polymer contains about 5 wt-% to about 65 wt-%, preferably about 10 wt-% to about 50 wt-%, and more preferably about 20 wt-% to about 40 wt-% solids.

In another embodiment, a sufficient amount of cross-linking agent is added to the aqueous polymer composition. Suitable cross-linking agents include any substance that will react with the hydrophilic groups of the aqueous solution polymer. In one embodiment, the selection and concentration of cross-linking agent will affect the absorbent rate and capacity. It is desirable that the cross-linking agent employed “reacts” with the functional groups on the polyacrylate polymer in less than 24 hours and at ambient (20° C.) and/or elevated temperatures.

In another embodiment, the polymerizable compounds may be polymerizable by any type of polymerization reaction, by use of a polymerization initiator that is activated, to initiate the polymerization. In one embodiment herein, the polymerization reaction is a free radical reaction, and the polymerizable compounds, e.g. monomers, comprise therefore groups that can form chemical bonds with one another in a radical reaction. Such a free radical polymerization reaction typically takes place in the presence of a radical initiator, as described below. Particularly suitable monomers may include an unsaturated group, e.g. a C═C group.

Monomers herein include ethylene oxide; propylene oxide; ethylenimine; but typically olefinically unsaturated carboxylates and/or carboxylic acids, and/or amides or esters thereof, for example, selected acrylic acids typified by acrylic acid itself, methacrylic acid, α-chloroacrylic acid, α-cyanoacrylic acid, β-methylacrylic acid (crotonic acid), α-phenylacrylic acid, β-acryloxypropionic acid, sorbic acid, α-chlorosorbic acid, angelic acid, cinnamic acid, p-chlorocinnamic acid, β-stearylacrylic acid, itaconic acid, citroconic acid, mesaconic acid, glutaconic acid, aconitic acid, maleic acid, fumaric acid, tricarboxyethylene, and maleic anhydride; and/or any of the carboxylates of these polymerizable compounds, e.g. carboxylate salts.

In another embodiment, the polymerizable compounds include or consist of acrylic acids and/or acrylate salts (and/or precursors thereof, such as typically acrylic esters).

In one embodiment, performance-enhancing additive(s) are added to the material. In one embodiment, the performance-enhancing additive(s) are antimicrobials. In one embodiment, the antimicrobial actives are boron containing compounds such as borax pentahydrate, borax decahydrate, boric acid, polyborate, tetraboric acid, sodium metaborate, anhydrous, boron components of polymers, and mixtures thereof.

In one embodiment, the odor absorbing/inhibiting active inhibits the formation of odors. An illustrative material is a water-soluble metal salt such as silver, copper, zinc, iron, and aluminum salts and mixtures thereof. In another embodiment, the metallic salts are zinc chloride, zinc gluconate, zinc lactate, zinc maleate, zinc salicylate, zinc sulfate, zinc ricinoleate, copper chloride, copper gluconate, and mixtures thereof. In another embodiment, the odor control actives include nanoparticles that may be composed of many different materials such as carbon, metals, metal halides or oxides, or other materials. Additional types of odor absorbing/inhibiting actives include cyclodextrin, zeolites, silicas, activated carbon (also known as activated charcoal), acidic, salt-forming materials, and mixtures thereof. Activated alumina (Al₂O₃) has been found to provide odor control comparable and even superior to other odor control additives such as activated carbon, zeolites, and silica gel. Alumina is a white granular material, and is also called aluminum oxide.

In some aspects, additional additives may optionally be employed with the particulate superabsorbent polymer compositions, including odor-binding substances, such as cyclodextrins, zeolites, inorganic or organic salts, and similar materials; anti-caking additives, flow modification agents, surfactants, viscosity modifiers, and the like. In addition, additives may be employed that perform several roles during modifications. For example, a single additive may be a surfactant, viscosity modifier, and may react to cross-link polymer chains.

In another embodiment, a color altering agent such as a dye, pigmented polymer, metallic paint, bleach, lightener, etc. may be added to vary the color of absorbent particles, such as to darken or lighten the color of all or parts of the composition so it is more appealing. In another embodiment, the color-altering agent comprises up to approximately 20% of the absorbent composition, more preferably, 0.001%-5% of the composition. In another embodiment, the color altering agent comprises approximately 0.01%-1% of the composition. In another embodiment, the carriers for the color-altering agent are zeolites, carbon, charcoal, etc. These substrates can be dyed, painted, coated with powdered colorant, etc.

The SAP can be introduced at a spray rate combined with the concentration of the water-soluble SAP to yield an amount of SAP in the final surfacing of 2 to 40 grams of SAP per square foot of surfacing. The preferred amount of SAP introduced per square foot of surfacing is from 6 to 10 grams.

In one embodiment, the present invention relates to a method and of cooling synthetic surfacing systems by modifying the surface tension/contact angle of the surface of the surfacing materials in order to enable wetting out of those materials as well as enabling capillary action within the surfacing. The standard synthetic PIP surfacing materials are extremely hydrophobic with high contact angle characteristics.

The objective with this invention is to provide a low cost non-mechanical method to cool synthetic PIP surfacing materials. This in turn will both improve the safety to users of synthetic as well as enhance the performance characteristics of the system. This invention does not increase the absorption of the surfacing materials but eliminates the hydrophobic aspect of the particles surface, which enables the interstitial or pore spaces to hold and move moisture through surface tension and capillary forces thereby increasing adsorption.

The various exemplary embodiments of the present invention include a method of coating various synthetic PIP surfacing materials with a surface-modifying agent. There are many types of materials that can be used as long as they meet performance, safety and cost objective.

The synthetic PIP surfacing system is designed for application over most substrates including rubber, tile, grass, hardpan dirt, engineered wood fiber, compacted stone and sand.

Dipping, spraying, and/or dot spraying an aqueous solution of the surface-modifying agent can coat the synthetic PIP surfacing system. In one embodiment, the surface of the synthetic PIP surfacing system shall be evenly coated

The coated synthetic PIP surfacing system can be dried in line immediately after the coating process or can be done at any time after it is coated. It can even be dried by ambient conditions after installation.

When the synthetic PIP surfacing system receives rainfall or irrigation the surface should readily expect the moisture and it will quickly wet out the surfacing filling the interstitial space as well as depositing a thin film of water on the surfacing. The coating material can be added in situ from time to time, if necessary.

Surface temperature levels of the improved synthetic PIP surfacing materials invention described in this document can be expected to be 25° to 40° cooler than standard synthetic PIP surfacing materials for a sustained period of time adding considerably to the value of the surfacing from a safety and performance perspective

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

An unexpected benefit of the invention is that it greatly improves the management of storm water by increasing the storage capacity of the surfacing aiding in the effective retention of storm water during a significant rain event.

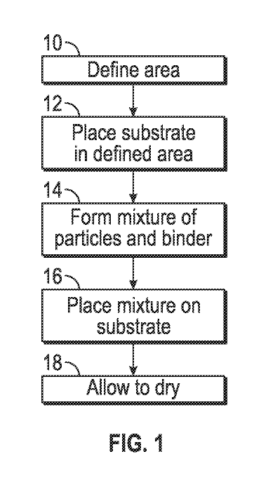

Referring to the accompanying drawings wherein like reference numerals refer to the same or similar elements, FIG. 1 is a flow chart showing an exemplifying method for manufacturing a poured in place surfacing on site in accordance with the invention. In one embodiment, the site at which the surfacing is to be formed must first be selected and prepared. Selection of the site may be a determination of a site for a playground, running track, athletic field, sports area, activity space, walking path, etc. Preparation of the site may include defining an area in which the surfacing is to be formed, step 10, and then placing substrate or loose fill material into the defined area, step 12. To define the area, the underlying ground surface may be worked as known to those skilled in the art. Alternatively, the ground surface does not have to be worked and may be left as is, e.g., ungraded, because the loose fill material will naturally fill in any voids or depressions in the ground surface.

The loose fill material constitutes a base layer and may include any material or combination of materials that meets the ASTM 1292 standard for impact attenuation. Examples of such materials include rubber mulch, wood chips, shredded tire rubber, pea gravel and loose foam. In a preferred embodiment, the loose fill material would include only recycled rubber particles without any binder.

A rubber-containing mixture that will cover the loose fill material is also prepared, step 14. The rubber-containing mixture includes rubber particles and one or more binders which will bind the rubber. The rubber particles and binder(s) are placed into a mixer, which would likely be situated at or proximate the prepared site at which the surfacing is to be formed. Although rubber particles are preferred, any shock-absorbing material may be used in the invention. The rubber particles generally have a granule size from about 0.5 mm to about 6 mm and/or may be thermoplastic vulcanized (TPV) granules. However larger or smaller sizes are acceptable.

The rubber particles may be fine rubber crumbs, small rubber chunks, rubber slivers/buffing and combinations thereof. Further, the rubber particles may be recycled rubber particles, e.g., from used tires or other rubber products such as shredded recycled tires.

Rubber particles include granular material, which may be fabricated of a rubber material. In another embodiment, the granular material comprises SBR crumb rubber. In one embodiment, the rubber particles have a median size that is within a range of about 5 to about 60 mesh.

In one embodiment, the rubber particles are made from styrene-butadiene or styrene-butadiene rubber (SBR) families of synthetic rubbers derived from styrene and butadiene. These materials have good abrasion resistance and good aging stability when protected by additives. In one embodiment, the rubber particles are black recycled rubber in particle sizes of 0.5 mm-4 mm.

In another embodiment, the rubber particles are made from EPDM rubber (ethylene propylene diene monomer (M-class) rubber), a type of synthetic rubber. EPDM rubber is primarily used because of its resistance to extremes of temperature and its general toughness.

In another embodiment, the rubber particles are made from TPV (Thermoplastic Vulcanizate) rubber granules for same applications like EPDM rubber granules. TPV granules are highly color stable, elastic, long lasting materials that can be used in athletic track facilities. EPDM and TPV granules with sizes 0.5-1.5 mm can be used for spray coating applications for running tracks and our 0.5-5 mm granules are used for multi purpose sport floors and playground floors.

The binders may each be any binder known to those skilled in the art which interacts with rubber particles and binds the rubber particles into a cohesive unit, e.g., when the binder is exposed to air for a certain amount of time. An example of a common binder used in this field is polyurethane. Two other types of common binders are SBR and acrylic binders. SBR binders are often used to increase sealing performance with oils. SBR binders generally will cause a material to swell or expand when in contact with oils. This property provides increased sealing performance by allowing the material to seal potential leak paths in an application. Acrylic binders are similar to those used in paints.

In one embodiment, a primer, which is used as an adhesive component between the sub-floor and the successive layers of surfacing such as recycled SBR with polyurethane binder and EPDM with polyurethane binder, is used. In one embodiment, the primer may be a clear, polyurethane-based, one-component resin.

Specific techniques to mix rubber particles and a binder are disclosed in U.S. Pat. No. 6,896,964, the entire disclosure of which is incorporated herein by reference above. A binder as used herein will also include any suitable liquid or polymeric liquid precursor that subsequently can form a polymer upon exposure to moisture in the air.

After the mixture is prepared and while still in its liquid form, it is placed over the substrate material, step 16. For example, the mixture can be transported by hand, pump, trough, spigot, wheelbarrow or buckets from the portable mixer to the defined area. The fluid mixture may be prevented from flowing outside of the area by appropriate shaping and working. The mixture is then allowed to dry (cure), step 18.

If the mixture will provide the uppermost layer of the poured in place surfacing when dry, then the mixture is preferably smoothed after it has been placed into the defined area and before it dries. The mixture may be smoothed by workers using trowels or by any other smoothing means known to those skilled in the art.

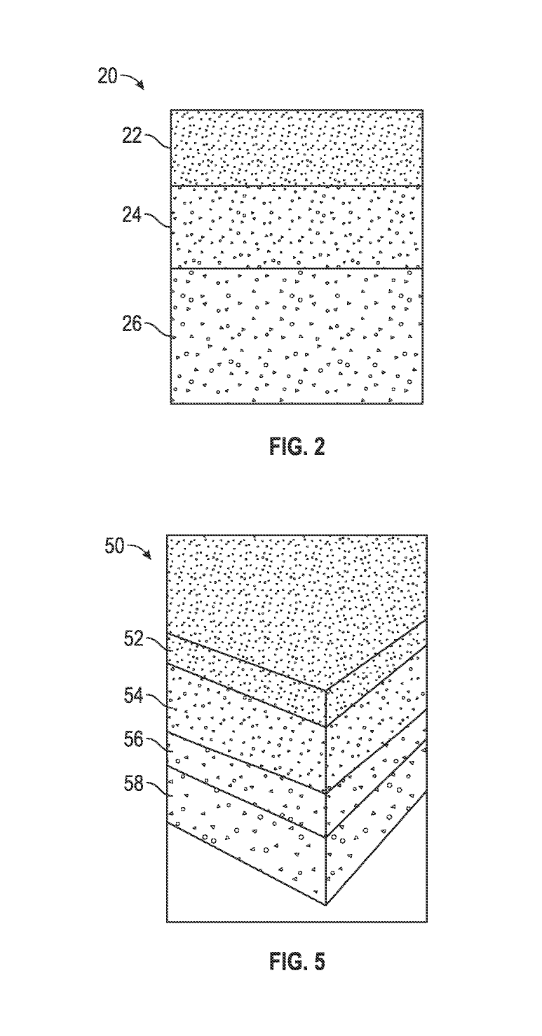

FIG. 2 shows the different layers of the poured in place surfacing 20 including a sub-base layer 26 of the loose fill material and an impact layer 24 of the dried rubber-containing mixture above the loose fill material. Optionally, the poured in place surfacing 20 may include a wear layer 22 on top of the impact layer 24. The edges of the poured in place surfacing may be smoothed into a smooth, level surface.

In another embodiment of the invention, a colored mixture is formed and placed over the above impact layer 24 after it has dried. This colored mixture may be colored, e.g., by adding one or more colorants to the mixture and/or using colored rubber particles. The colorant is mixed with the rubber particles and the binder(s) in the portable mixer after drying of the first mixture, e.g., a day later, and then placed over the dried first mixture. In another embodiment, colorant, colored particles or both may be added to any of the surfacing layers. If the second mixture is to be applied, the first mixture would not have to be smoothed after it is applied since it is being covered by the colored mixture and thus only the colored mixture would have to be smoothed, assuming it provides the uppermost surface of the surfacing. Any number of additional layers over the first layer may be provided.

In another embodiment of the invention, a sub-base material 26 is formed and placed below the impact layer 24 before it is placed. In another embodiment, the poured in place surfacing formation methods include methods in which a sub-base 26 of crushed aggregate or hard surface layer, an impact layer 24 and a top wear layer 22 are required. In another embodiment, grading of the site at which the poured in place surfacing is to be formed is not required because the loose fill material will fill voids in the ground and moreover, a sub-base is not required.

In one embodiment, the wet pour play surfacing comprises a variable depth multi-layer system. In one embodiment, the surface depth is from about 10 to about 200 mm.

In one embodiment, the base impact layer 24 consists of granular SBR recycled rubber, which sits on top of the specified sub-base 26 of compacted soil or aggregate. The SBR layer can be from about 10 mm to 150 mm deep, depending on the specific application. In one embodiment, the top wear layer comprises a high grade play area specific EPDM rubber granule mixture with a polymer resin binder in a depth of from about 5 to about 25 mm. In another embodiment, a polyurethane resin binder is used for both the SBR and EPDM granular layers.

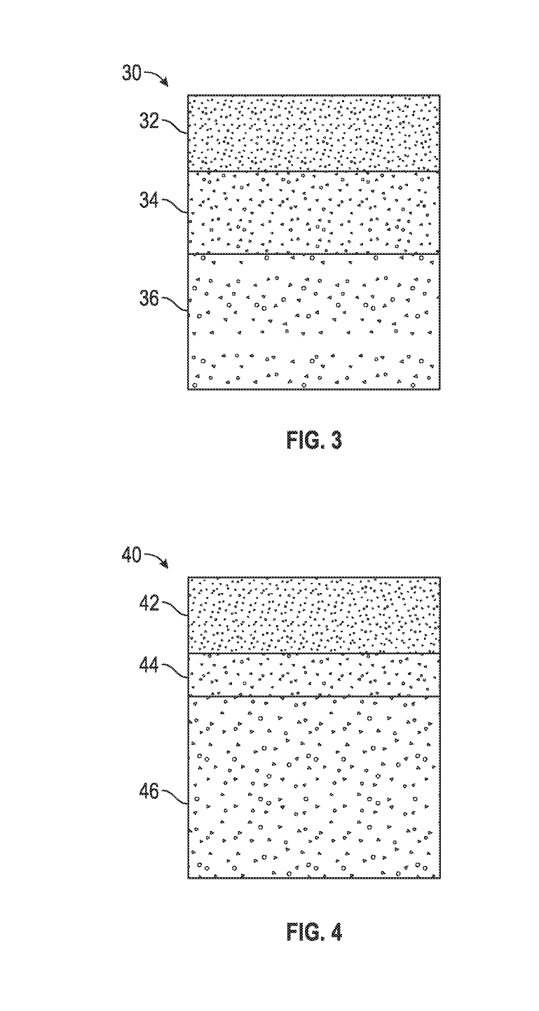

FIG. 3 shows the different layers of the poured in place sports surfacing 30 in accordance with the invention wherein the base layer 32 sits on top of a specified sub-base 34. The base layer 32 may be an impact layer, wear layer or both. The suitable sub-base 34 is shown on top of a substrate base 36. In one embodiment, the substrate base 36 is soil. In another embodiment, the substrate base 36 is compacted aggregate particles.

In one embodiment, the base layer 32 consists of a top wear layer comprising a high grade play area specific EPDM rubber granule mixture with a polymer resin binder in a depth of from about 1 to about 5 mm. In another embodiment, a polyurethane resin binder is used for the EPDM granular layers. In another embodiment, the top layer is a SBR, EPDM, TPV granular particles or mixtures thereof.

In one embodiment, the sports surfacing is a two layer porous impact absorbing in-situ rubber safety surface system. The surfacing has a continuous appearance, which is generally installed on flat areas but can also be installed over mounded or ramped sub structures. The safety surface can be installed in Black EPDM, a single colour EPDM or in multi-coloured designs. The surfacing can be installed onto various sub bases. Impact absorbing rubber surfacing is more commonly installed onto a compacted MOT type 1 stone sub base. An alternate sub base is a solid porous surface, such as open textured porous macadam or no fines concrete. A surfacing base course may be provided from 100% Recycled SBR (Styrene Butadiene Rubber) rubber crumb which is mixed with a polyurethane resin binder. The impact absorbing base layer can be varied in depth to meet the required Critical Fall Height (CFH) of any play equipment. Full system thicknesses vary between 30 mm and 150 mm.

FIG. 4 shows the different layers of the poured in place flooring surfacing 40 in accordance with the invention wherein the base layer 42 sits on top of a flooring sub-base 44. The impact layer and flooring are shown on top of a suitable hard substrate base 46.

In one embodiment, the flooring surfacing 40 is a pool surround and wet area flooring surface that is a permeable single layer polymeric surface, consisting of 1-3 mm rubber granules mixed together with a solvent-free polyurethane resin binder. In one embodiment, the base layer 42 is a 1-3 mm EPDM rubber granule layer that is placed on top of an existing flooring sub-base 44, such as ceramic tile or concrete. In one embodiment, the EPDM rubber granules form a layer that is ¼ to about ½ inch in thickness, mixed with 20-30% binder to rubber ratio. In another embodiment, the SBR rubber particles form a layer of 1-4 inches thick and are mixed with 10-20% binder (such as polyurethane) to rubber ratio.

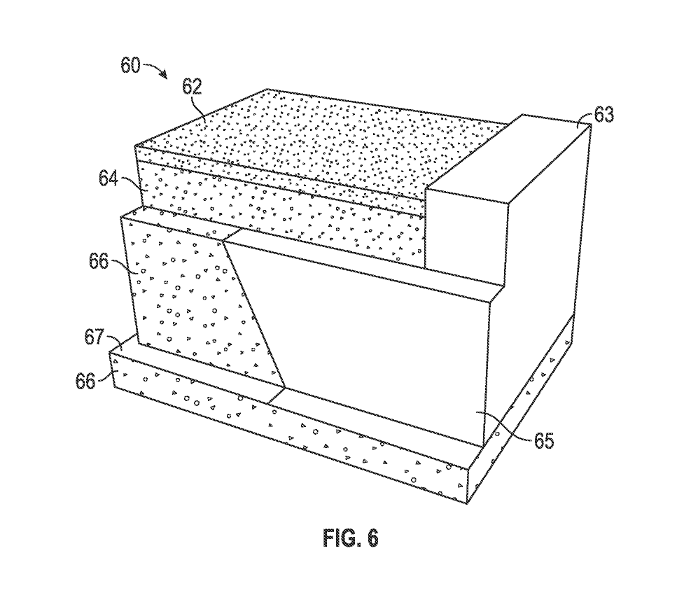

FIG. 5 shows the different layers of the poured in place surfacing 50 in accordance with the invention wherein the impact layer 54 sits on top of a specified two-layer sub-base. The system sits on top of a first sub-base layer 56 that sits on top of a second sub-base layer 58. Shown is an optional wear layer 52 on top.

While there are several different types of suitable sub-surfaces, one sub-surface for surfacing is properly placed and cured concrete or asphalt. In another embodiment, the surfacing can alternatively be installed over a properly graded, leveled and compacted sub base of a 1-4 inches of aggregate of the correct size, type and consistency, covered by a layer of properly leveled and compacted “chip dust” or “granite screenings” (¼ inch minus).

In one embodiment, the poured in place surfacing 50 sits on top of a first sub-base layer 56 comprising a layer of properly leveled and compacted “chip dust” or “granite screenings” (¼ inch to ½ inch) compacted to about 98% SPD that sits on top of a compacted second sub-base layer 58 of properly graded, leveled and compacted sub base of a 1-8 inches of granular packing aggregate of the correct size, type and consistency compacted to about 98% SPD.

FIG. 6 shows the different layers of the poured in place poured in place surfacing system 60 in accordance with the invention wherein the impact layer 64 sits on top of a specified sub-base. The system sits on top of either a hard sub-base layer 65 or a compacted aggregate sub-base layer 66 or both. Either may optionally sit on top of a compacted second sub-base layer 68. Optional geotextile 67 is shown placed between the first and second sub-base layers. Shown is an optional wear layer 62 on top. Additionally, an optional border 63 is shown.

With the foregoing structure, a poured in place surfacing in accordance with the invention provides significant advantages over prior art poured in place surfacings. In one embodiment, the base layer includes loose fill material, which is not limited to rubber materials and may include only non-rubber materials, only loose rubber materials without a binder, only recycled material, or only recycled loose rubber materials without a binder. In other embodiments, the base layer is comprised exclusively of rubber granules that are contained in either a bagged system (Smarte) or are mixed with polyurethane binders that form them into a unitary structure.

In another embodiment, EPDM (Ethylene Propylene Diene Monomer) materials may be used in the top layer. Some embodiments of a surfacing in accordance with the invention may include a top layer with EPDM materials and TPV granules. An SBR blend may also be used, e.g., ground up tires, which includes small particulates that are blended with a binder/coloring agent.

In another embodiment, the poured in place surfacing formation methods include methods in which a sub-base of crushed stone or asphalt, a base layer and a top coat are required. In another embodiment, grading of the site at which the poured in place surfacing is to be formed is not required because the loose fill material will fill voids in the ground and moreover, a sub-base is not required.

In another embodiment, the surfacing materials made be modified to provide for hydrophilic surfaces by a wide variety of processes. In one embodiment, the process used is the treatment of the surface of polymers with plasma. In one embodiment, the plasma is a microwave plasma or of low-pressure plasma. As used herein, the term “plasma treatment” comprises conventional methods for plasma-treating materials suitable for use with the present invention.

In one embodiment, the hydrophilic surfaces are created from plasma treatments wherein the plasmas are created using one or more of oxygen plasmas, CO₂ plasmas. NO plasmas, and NO₂ plasmas. If oxygen is used, the polymer surfaces are modified so as to form functional groups, such as hydroxy, carbonyl, carboxy, and peroxide groups. The use of nitrogen and ammonia promote the formation of amine functions and imine functions. These polar, hydrophilic groups drastically alter chemical properties and improve the wettability of these surfaces. In one embodiment, the hydrophilic surfaces have contact angles of a few degrees.

In one embodiment, the present invention provides for materials and methods for coating various rubber surfacing particles with a surface-modifying agent wherein the agent is a surfactant. In one embodiment, the surfactant can be any surfactant suitable for use agriculture, coating, painting, medical applications and cosmetics. In one embodiment, the surfactants can be anionic, cationic, zwitterionic or non-ionic. Mixtures of surfactants are also within the scope of the invention, as are combinations of surfactant and other additives

In accordance with any of the above embodiments, the invention further comprises a surface modification of the rubber surfacing particles. In certain embodiments, the surface modification alters a property selected from the group consisting of surface charge, surface charge density, surface hydrophobicity, and surface charge and hydrophobicity combined.

In one embodiment, the agent composition comprises from about 0.01 to about 5% (w/w) of a surfactant. In one embodiment, the agent composition comprises from about 0.01 to about 1% (w/w). In one embodiment, the agent composition comprises from about 0.03 to about 0.5% (w/w) of a surfactant. The surfactant can be any surfactant that assists in modifying the surface tension/contact angle of the surface of the surfacing materials in order to enable wetting out of those materials as well as enabling capillary action within the infill matrix. In one embodiment, the composition used in the present invention does not increase the absorption of the surfacing materials but eliminates the hydrophobic aspect of the rubber particle surface within the surfacing, which enables the interstitial/pore spaces to hold and move moisture through surface tension and capillary forces.

In one embodiment, the surfactant is a hydrophilic surfactant. In one embodiment, the surfactant compound has an HLB value greater than about 10, as well as anionic, cationic, or zwitterionic compounds for which the HLB scale is not generally applicable.

An empirical parameter commonly used to characterize the relative hydrophilicity and hydrophobicity of surfactants is the hydrophilic-lipophilic balance (“HLB” value). Surfactants with lower HLB values are more hydrophobic, and have greater solubility in oils, while surfactants with higher HLB values are more hydrophilic, and have greater solubility in aqueous solutions. Using HLB values as a rough guide, hydrophilic surfactants are generally considered to be those compounds having an HLB value greater than about 10, as well as anionic, cationic, or zwitterionic compounds for which the HLB scale is not generally applicable. Similarly, hydrophobic surfactants are compounds having an HLB value less than about 10. In certain embodiments of the present invention, a higher HLB value is preferred, since increased hydrophilicity may facilitate aqueous materials from entering the micropores of the surface of the infill material.

In one embodiment, the HLB of the surfactant additive is higher than 5. In one embodiment, the HLB of the surfactant additive is higher than 9. In another embodiment, the additive HLB is higher than 14. The HLB values of surfactant additives in certain embodiments are in the range of 0.0-40.

It should be understood that the HLB value of a surfactant is merely a rough guide generally used to enable formulation of industrial, pharmaceutical and cosmetic emulsions, for example. For many important surfactants, including several polyethoxylated surfactants, it has been reported that HLB values can differ by as much as about 8 HLB units, depending upon the empirical method chosen to determine the HLB value (Schott, J. Pharm. Sciences, 79(1), 87-88 (1990)). Keeping these inherent difficulties in mind, and using HLB values as a guide, surfactants may be identified that have suitable hydrophilicity or hydrophobicity for use in embodiments of the present invention, as described herein.

PEG-Fatty Acids and PEG-Fatty Acid Mono and Diesters

Although polyethylene glycol (PEG) itself does not function as a surfactant, a variety of PEG-fatty acid esters have useful surfactant properties. Among the PEG-fatty acid monoesters, esters of lauric acid, oleic acid, and stearic acid, myristoleic acid, palmitoleic acid, linoleic acid, linolenic acid, eicosapentaenoic acid, erucic acid, ricinoleic acid, and docosahexaenoic acid are most useful in embodiments of the present invention. In one embodiment, the hydrophilic surfactants include PEG-8 laurate, PEG-8 oleate, PEG-8 stearate, PEG-9 oleate, PEG-10 laurate. PEG-10 oleate, PEG-12 laurate, PEG-12 oleate, PEG-15 oleate, PEG-20 laurate and PEG-20 oleate. The HLB values are in the range of 4-20.

Polyethylene glycol fatty acid diesters are also suitable for use as surfactants in the compositions of embodiments of the present invention. In one embodiment, the hydrophilic surfactants include PEG-20 dilaurate, PEG-20 dioleate. PEG-20 distearate, PEG-32 dilaurate and PEG-32 dioleate. The HLB values are in the range of 5-15.

In one embodiment, mixtures of surfactants are also useful in embodiments of the present invention, including mixtures of two or more commercial surfactants as well as mixtures of surfactants with another additive or additives. Several PEG-fatty acid esters are marketed commercially as mixtures or mono- and diesters.

Polyethylene Glycol Glycerol Fatty Acid Esters

In one embodiment, the hydrophilic surfactants are PEG-20 glyceryl laurate. PEG-30 glyceryl laurate, PEG-40 glyceryl laurate, PEG-20 glyceryl oleate, and PEG-30 glyceryl oleate.

Alcohol-Oil Transesterification Products

A large number of surfactants of different degrees of hydrophobicity or hydrophilicity can be prepared by reaction of alcohols or polyalcohol with a variety of natural and/or hydrogenated oils. Most commonly, the oils used are castor oil or hydrogenated castor oil, or an edible vegetable oil such as corn oil, olive oil, peanut oil, palm kernel oil, apricot kernel oil, or almond oil. Preferred alcohols include glycerol, propylene glycol, ethylene glycol, polyethylene glycol, sorbitol, and pentaerythritol. Among these alcohol-oil transesterified surfactants, preferred hydrophilic surfactants are PEG-35 castor oil, polyethylene glycol-glycerol ricinoleate (Incrocas-35, and Cremophor EL&ELP), PEG-40 hydrogenated castor oil (Cremophor RH 40), PEG-15 hydrogenated castor oil (Solutol HS 15), PEG-25 trioleate (TAGAT® TO). PEG-60 corn glycerides (Crovol M70), PEG-60 almond oil (Crovol A70), PEG-40 palm kernel oil (Crovol PK70), PEG-50 castor oil (Emalex C-50), PEG-50 hydrogenated castor oil (Emalex HC-50), PEG-8 caprylic/capric glycerides (Labrasol), and PEG-6 caprylic/capric glycerides (Softigen 767). Preferred hydrophobic surfactants in this class include PEG-5 hydrogenated castor oil, PEG-7 hydrogenated castor oil, PEG-9 hydrogenated castor oil, PEG-6 corn oil (Labrafil® M 2125 CS), PEG-6 almond oil (Labrafil® M 1966 CS), PEG-6 apricot kernel oil (Labrafil® M 1944 CS), PEG-6 olive oil (Labrafil® M 1980 CS), PEG-6 peanut oil (Labrafil® M 1969 CS), PEG-6 hydrogenated palm kernel oil (Labrafil® M 2130 BS), PEG-6 palm kernel oil (Labrafil® M 2130 CS), PEG-6 triolein (Labrafil®b M 2735 CS), PEG-8 corn oil (Labrafil® WL 2609 BS), PEG-20 corn glycerides (Crovol M40), and PEG-20 almond glycerides (Crovol A40).

Polyalyceryl Fatty Acids

Polyglycerol esters of fatty acids are also suitable surfactants for use in embodiments of the present invention. Among the polyglyceryl fatty acid esters, preferred hydrophobic surfactants include polyglyceryl oleate (Plurol Oleique), polyglyceryl-2 dioleate (Nikko) DGDO), polyglyceryl-10 trioleate, polyglyceryl stearate, polyglyceryl laurate, polyglyceryl myristate, polyglyceryl palmitate, and polyglyceryl linoleate. Preferred hydrophilic surfactants include polyglyceryl-10 laurate (Nikkol Decaglyn 1-L), polyglyceryl-10 oleate (Nikkol Decaglyn 1-O), and polyglyceryl-10 mono, dioleate (Caprol® PEG 860), polyglyceryl-10 stearate, polyglyceryl-10 laurate, polyglyceryl-10 myristate, polyglyceryl-10 palmitate, polyglyceryl-10 linoleate, polyglyceryl-6 stearate, polyglyceryl-6 laurate, polyglyceryl-6 myristate, polyglyceryl-6 palmitate, and polyglyceryl-6 linoleate. Polyglyceryl polyricinoleates (Polymuls) are also preferred surfactants.

Propylene Glycol Fatty Acid Esters

In one embodiment, esters of propylene glycol and fatty acids are suitable surfactants for use in embodiments of the present invention. In this surfactant class, preferred hydrophobic surfactants include propylene glycol monolaurate (Lauroglycol FCC), propylene glycol ricinoleate (Propymuls), propylene glycol monooleate (Myverol P-O6), propylene glycol dicaprylate/dicaprate (Captex® 200), and propylene glycol dioctanoate (Captex® 800).

Sterol and Sterol Derivatives

In one embodiment, sterols and derivatives of sterols are suitable surfactants for use in embodiments of the present invention. Preferred derivatives include the polyethylene glycol derivatives. In one embodiment, the surfactant in this class is PEG-24 cholesterol ether (Solulan C-24).

Polyethylene Glycol Sorbitan Fatty Acid Esters

In one embodiment, a variety of PEG-sorbitan fatty acid esters are available and are suitable for use as surfactants in embodiments of the present invention. In one embodiment, the PEG-sorbitan fatty acid esters, preferred surfactants include PEG-20 sorbitan monolaurate (Tween-20), PEG-4 sorbitan monolaurate (Tween-21), PEG-20 sorbitan monopalmitate (Tween-40). PEG-20 sorbitan monostearate (Tween-60). PEG-4 sorbitan monostearate (Tween-61). PEG-20 sorbitan monooleate (Tween-80), PEG-4 sorbitan monooleate (Tween-81), PEG-20 sorbitan trioleate (Tween-85). Laurate esters are preferred because they have a short lipid chain compared with oleate esters, increasing drug absorption.

Polyethylene Glycol Alkyl Ethers

Ethers of polyethylene glycol and alkyl alcohols are suitable surfactants for use in embodiments of the present invention. Preferred ethers include Lanethes (Laneth-5, Laneth-10, Laneth-15, Laneth-20, Laneth-25, and Laneth-40), laurethes (Laureth-5, laureth-10, Laureth-15, laureth-20, Laureth-25, and laureth-40), Olethes (Oleth-2, Oleth-5, Oleth-10, Oleth-12, Oleth-16, Oleth-20, and Oleth-25), Stearethes (Steareth-2, Steareth-7, Steareth-8, Steareth-10, Steareth-16, Steareth-20, Steareth-25, and Steareth-80), Cetethes (Ceteth-5, Ceteth-10, Ceteth-15, Ceteth-20, Ceteth-25, Ceteth-30, and Ceteth-40). PEG-3 oleyl ether (Volpo 3) and PEG-4 lauryl ether (Brij 30).

Sugar Derivatives

Sugar derivatives are suitable surfactants for use in embodiments of the present invention. Preferred surfactants in this class include sucrose monopalmitate, sucrose monolaurate, decanoyl-N-methylglucamide, n-decyl-.beta.-D-glucopyranoside, n-decyl-.beta.-D-maltopyranoside, n-dodecyl-.beta.-D-glucopyranoside, n-dodecyl-.beta.-D-maltoside, heptanoyl-N-methylglucamide, n-heptyl-.beta.-D-glucopyranoside, n-heptyl-.beta.-D-thioglucoside, n-hexyl-.beta.-D-glucopyranoside, nonanoyl-N-methylglucamide, n-noyl-.beta.-D-glucopyranoside, octanoyl-N-methylglucamide, n-octyl-.beta.-D-glucopyranoside, and octyl-.beta.-D-thioglucopyranoside.

Polyethylene Glycol Alkyl Phenols

In one embodiment, the PEG-alkyl phenol surfactants, such as PEG-10-100 nonyl phenol and PEG-15-100 octyl phenol ether, Tyloxapol, octoxynol, nonoxynol, are suitable for use in embodiments of the present invention.

Polyoxyethylene-Polyoxypropylene (POE-POP) Block Copolymers

The POE-POP block copolymers are a unique class of polymeric surfactants. The unique structure of the surfactants, with hydrophilic POE and hydrophobic POP moieties in well-defined ratios and positions, provides a wide variety of surfactants suitable for use in embodiments of the present invention. These surfactants are available under various trade names, including Synperonic PE series (ICI); Pluronic® series (BASF), Emkalyx, Lutrol (BASF), Supronic, Monolan, Pluracare, and Plurodac. The generic term for these polymers is “poloxamer” (CAS 9003-11-6). These polymers have the formula: HO(C2H4O)a(C3H6O)b(C2H4O)aH where “a” and “b” denote the number of polyoxyethylene and polyoxypropylene units, respectively.

Preferred hydrophilic surfactants of this class include Poloxamers 108, 188, 217, 238, 288, 338, and 407. In one embodiment, the hydrophobic surfactants in this class include Poloxamers 124, 182, 183, 212, 331, and 335.

Polyester-Polyethylene Glycol Block Copolymers

The polyethylene glycol-polyester block copolymers are a unique class of polymeric surfactants. The unique structure of the surfactants, with hydrophilic polyethylene glycol (PEG) and hydrophobic polyester moieties in well-defined ratios and positions, provides a wide variety of surfactants suitable for use in embodiments of the present invention. The polyesters in the block polymers include poly(L-lactide) (PLLA), poly(DL-lactide) (PDLLA), poly(D-lactide) (PDLA), polycaprolactone (PCL), polyesteramide (PEA), polyhydroxyalkanoates, polyhydroxybutyrate (PHB), polyhydroxybutyrate-co-hydroxyvalerates (PHBV), polyhydroxybutyrate-co-hydroxyhexanoate (PHBHx), polyaminoacids, polyglycolide or polyglycolic acid (PGA), polyglycolide and its copolymers (poly(lactic-co-glycolic acid) with lactic acid, poly(glycolide-co-caprolactone) with .epsilon.-caprolactone, and poly (glycolide-co-trimethylene carbonate) with trimethylene carbonate), and their copolyesters. Examples are PLA-b-PEG, PLLA-b-PEG, PLA-co-PGA-b-PEG, PCL-co-PLLA-b-PEG, PCL-co-PLLA-b-PEG, PEG-b-PLLA-b-PEG, PLLA-b-PEG-b-PLLA, PEG-b-PCL-b-PEG, and other di, tri and multiple block copolymers. The hydrophilic block can be other hydrophilic or water soluble polymers, such as polyvinylalcohol, polyvinylpyrrolidone, polyacrylamide, and polyacrylic acid.

Polyethylene Glycol Graft Copolymers

One example of the graft copolymers is Soluplus (BASF, German). The Soluplus is a polyvinyl caprolactam-polyvinyl acetate-polyethylene glycol graft copolymer. The copolymer is a solubilizer with an amphiphilic chemical structure, which is capable of solubilizing poorly soluble drugs, such as paclitaxel, rapamycin and their derivatives, in aqueous media. Molecular weight of the copolymer is in the range of 90,000-140 000 g/mol.

Polymers, copolymers, block copolymers, and graft copolymers with amphiphilic chemical structures are used as additives in the inventions. The polymers with amphiphilic chemical structures are block or graft copolymers. There are multiple segments (at least two segments) of different repeated units in the copolymers. In some embodiments, one of the segments is more hydrophilic than other segments in the copolymers. Likewise, one of the segments is more hydrophobic than other segments in the copolymers. For example, the polyethylene glycol segment is more hydrophilic than polyvinyl caprolactam-polyvinyl acetate segments in Soluplus (BASF, German). The polyester segment is more hydrophobic than polyethylene glycol segment in polyethylene glycol-polyester block copolymers. PEG is more hydrophilic the PLLA in PEG-PLLA. PCL is more hydrophobic than PEG in PEG-b-PCL-b-PEG. The hydrophilic segments are not limited to polyethylene glycol. Other water soluble polymers, such as soluble polyvinylpyrrolidone and polyvinyl alcohol, can form hydrophilic segments in the polymers with amphilic structure. The copolymers can be used in combination with other additives in the inventions.

Sorbitan Fatty Acid Esters

Sorbitan esters of fatty acids are suitable surfactants for use in embodiments of the present invention. Among these esters, preferred hydrophobic surfactants include sorbitan monolaurate (Arlacel 20), sorbitan monopalmitate (Span-40), and sorbitan monooleate (Span-80), sorbitan monostearate.

The sorbitan monopalmitate, an amphiphilic derivative of Vitamin C (which has Vitamin C activity), can serve two important functions in solubilization systems. First, it possesses effective polar groups that can modulate the microenvironment. These polar groups are the same groups that make vitamin C itself (ascorbic acid) one of the most water-soluble organic solid compounds available: ascorbic acid is soluble to about 30 wt/wt % in water (very close to the solubility of sodium chloride, for example). And second, when the pH increases so as to convert a fraction of the ascorbyl palmitate to a more soluble salt, such as sodium ascorbyl palmitate.

Ionic Surfactants

In another embodiment, ionic surfactants, including cationic, anionic and zwitterionic surfactants, are suitable hydrophilic surfactants for use in embodiments of the present invention.

Anionic surfactants are those that carry a negative charge on the hydrophilic part. The major classes of anionic surfactants used as additives in embodiments of the invention are those containing carboxylate, sulfate, and sulfonate ions. Preferable cations used in embodiments of the invention are sodium, calcium, magnesium, and zinc. The straight chain is typically a saturated or unsaturated C8-C18 aliphatic group. Anionic surfactants with carboxylate ions include aluminum stearate, sodium stearate, calcium stearate, magnesium stearate, zinc stearate, sodium, zinc, and potassium oleates, sodium stearyl fumarate, sodium lauroyl sarcosinate, and sodium myristoyl sarcosinate. Anionic surfactants with sulfate group include sodium lauryl sulfate, sodium dodecyl sulfate, mono-, di-, and triethanolamine lauryl sulfate, sodium lauryl ether sulfate, sodium cetostearyl sulfate, sodium cetearyl sulfate, sodium tetradecyl sulfate, sulfated castor oil, sodium cholesteryl sulfate, sodium tetradecyl sulfate, sodium myristyl sulfate, sodium octyl sulfate, other mid-chain branched or non-branched alkyl sulfates, and ammonium lauryl sulfate. Anionic surfactants with sulfonate group include sodium docusate, dioctyl sodium sulfosuccinate, sodium lauryl sulfoacetate, sodium alkyl benzene sulfonate, sodium dodecyl benzene sulfonate, diisobutyl sodium sulfosuccinate, diamyl sodium sulfosuccinate, di(2-ethylhexyl)sulfosuccinate, and bis(1-methylamyl) sodium sulfosuccinate.

The most common surfactants used in embodiments of the invention are the quaternary ammonium compounds with the general formula R1, R2, R3, R4N+X−, where X− is usually chloride or bromide ion and R represents alkyl groups containing C8-18 atoms. In another embodiment, the surfactants include cetrimide, cetrimonium bromide, benzalkonium chloride, benzethonium chloride, cetylpyridinium chloride, hexadecyltrimethyl ammonium chloride, stearalkonium chloride, lauralkonium chloride, tetradodecyl ammonium chloride, myristyl picolinium chloride, and dodecyl picolinium chloride.

Zwitterionic or amphoteric surfactants include dodecyl betaine, cocamidopropyl betaine, cocoampho clycinate, among others.

In one embodiment, the ionic surfactants include sodium lauryl sulfate, sodium dodecyl sulfate, sodium lauryl ether sulfate, sodium cetostearyl sulfate, sodium cetearyl sulfate, sodium tetradecyl sulfate, sulfated castor oil, sodium cholesteryl sulfate, sodium tetradecyl sulfate, sodium myristyl sulfate, sodium octyl sulfate, other mid-chain branched or non-branched alkyl sulfates, sodium docusate, dioctyl sodium sulfosuccinate, sodium lauryl sulfoacetate, sodium alkyl benzene sulfonate, sodium dodecyl benzene sulfonate, benzalkonium chloride, benzethonium chloride, cetylpyridinium chloride, docecyl trimethyl ammonium bromide, sodium docecylsulfates, dialkyl methylbenzyl ammonium chloride, edrophonium chloride, domiphen bromide, dialkylesters of sodium sulfonsuccinic acid, sodium dioctyl sulfosuccinate, sodium cholate, and sodium taurocholate. These quaternary ammonium salts are preferred additives. They can be dissolved in both organic solvents (such as ethanol, acetone, and toluene) and water. This is especially useful for infill particle coatings because it simplifies the preparation and coating process and has good adhesive properties. HLB values of these surfactants are typically in the range of 20-40, such as sodium dodecyl sulfate (SDS), which has HLB values of 38-40.

Chemical Compounds with One or More Hydroxyl. Amino, Carbonyl, Carboxyl, Acid, Amide or Ester Moieties

The chemical compounds with one or more hydroxyl, amino, carbonyl, carboxyl, acid, amide or ester moieties include amino alcohols, hydroxyl carboxylic acid, ester, and anhydrides, hydroxyl ketone, hydroxyl lactone, hydroxyl ester, sugar phosphate, sugar sulfate, ethyl oxide, ethyl glycols, amino acids, peptides, proteins, sorbitan, glycerol, polyalcohol, phosphates, sulfates, organic acids, esters, salts, vitamins, combinations of amino alcohols and organic acids, and their substituted molecules. In another embodiment, hydrophilic chemical compounds with one or more hydroxyl, amino, carbonyl, carboxyl, acid, amide or ester moieties having a molecular weight less than 5,000-10,000 are preferred in certain embodiments. In other embodiments, molecular weight of the additive with one or more hydroxyl, amino, carbonyl, carboxyl, acid, amide, or ester moieties is preferably less than 1000-5,000, or more preferably less than 750-1,000, or most preferably less than 750.

The chemical compounds with amide moieties are important to the coating formulations in certain embodiments of the invention. Urea is one of the chemical compounds with amide groups. Others include biuret, acetamide, lactic acid amide, aminoacid amide, acetaminophen, uric acid, polyurea, urethane, urea derivatives, niacinamide, N-methylacetamide, N,N-dimethylacetamide, sulfacetamide sodium, versetamide, lauric diethanolamide, lauric myristic diethanolamide, N,N-Bis(2-hydroxyethyl stearamide), cocamide MEA, cocamide DEA, arginine, and other organic acid amides and their derivatives. Some of the chemical compounds with amide groups also have one or more hydroxyl, amino, carbonyl, carboxyl acid or ester moieties.

One of the chemical compounds with amide group is a soluble and low molecular weight povidone. The povidone includes Kollidon 12 PF, Kollidon 17 PF, Kollidon 17, Kollidon 25, and Kollidon 30. The Kollidon products consist of soluble and insoluble grades of polyvinylpyrrolidone of various molecular weights and particle sizes, a vinylpyrrolidone/vinyl acetate copolymer and blend of polyvinyl acetate and polyvinylpyrrolidone. The family products are entitled Povidone, Crospovidone and Copovidone. The low molecular weights and soluble Povidones and Copovidones are especially important additives in the inventions. For example, Kollidon 12 PF, Kollidon 17 PF, and Kollidon 17 are very important. The solid povidone can keep integrity of the coating on the rubber particles. The low molecular weight povidone can be absorbed or permeated into the diseased tissue. The preferred range of molecular weight of the povidone are less than 54000, less than 11000, less than 7000, less than 4000. They can solublize the water insoluble therapeutic agents. Due to these properties of solid, low molecular weight and tissue absorption/permeability, the Povidone and Copovidone are especially useful in the inventions. The Povidone can be used in combinations with other additives in the inventions. In one embodiment Povidone and a nonionic surfactant (such as PEG-15 12-hydroxystearate (Solutol HS 15), Tween 20, Tween 80, Cremophor RH40, Cremophor EL &ELP), can be formulated with paclitaxel or rapamycin or their analogue as a coating for rubber particles, such as balloon catheters.

The chemical compounds with ester moieties are especially important to the coating formulations in certain embodiments. The products of organic acid and alcohol are the chemical compounds with ester groups. The chemical compounds with ester groups often are used as plasticers for polymeric materials. The wide variety of ester chemical compounds includes sebates, adipates, gluterates, and phthalates. The examples of these chemical compounds are bis(2-ethylhexyl) phthalate, di-n-hexyl phthalate, diethyl phthalate, bis(2-ethylhexyl) adipate, dimethyl adipate, dioctyl adipate, dibutyl sebacate, dibutyl maleate, triethyl citrate, acetyl triethyl citrate, trioctyl citrate, trihexyl citrate, butyryl trihexyl citrate, and trimethyl citrate.

Solvents

Solvents for preparing of the surface-modifying coating layer may include, as examples, any combination of one or more of the following: (a) water, (b) alkanes such as hexane, octane, cyclohexane, and heptane, (c) aromatic solvents such as benzene, toluene, and xylene, (d) alcohols such as ethanol, propanol, and isopropanol, diethylamide, ethylene glycol monoethyl ether, Trascutol, and benzyl alcohol (e) ethers such as dioxane, dimethyl ether and tetrahydrofuran, (f) esters/acetates such as ethyl acetate and isobutyl acetate, (g) ketones such as acetone, acetonitrile, diethyl ketone, and methyl ethyl ketone, and (h) mixture of water and organic solvents such as water/ethanol, water/acetone, water/methanol, water/tetrahydrofuran. In one embodiment, the solvent is water and alcohol. In another embodiment, the solvent is water and isopropyl alcohol.

Organic solvents, such as short-chained alcohol, dioxane, tetrahydrofuran, dimethylformamide, acetonitrile, dimethylsulfoxide, etc., are particularly useful solvents in embodiments of the present invention. In other embodiments, two or more solvents may be used in the coating solution.

The term “aqueous medium” is meant water, buffered water including phosphate buffered water, phosphate buffered saline, citrate buffered water, acetate buffered water, water buffered with pharmaceutically acceptable pH controlling agents; water containing salts such as sodium chloride and other pharmaceutically acceptable salts; water containing soluble agents for lyoprotection or cryoprotection such as dextrose, mannitol, trehalose, sucrose, sorbitol, and other pharmaceutically acceptable lyoprotectants and cryoprotectants; water containing soluble agents used to facilitate spray drying such as polyhydroxy-containing compounds such as sugars, polyols, and water containing mixtures of these buffers, agents and compounds. In one embodiment, the aqueous medium can contain one or more soluble surface-active agent. In another embodiment, the aqueous medium can contain one or more surfactants dispersed such as by shear mixing into water or other aqueous medium as described herein.

One or more surfactants utilized in the carrier of this invention is termed a surfactant system or surface-modifying agent. In those compositions possessing more than one surface-active agent, the principle surface active agent that is present in larger quantity is called the surfactant and the other surface active agents are named as co-surfactants.

In one embodiment, the compositions of this invention include a surfactant system comprising at least one hydrophilic component. The hydrophilic component when optionally used comprises less than about 10% of the carrier system. Examples of hydrophilic components include low-molecular weight monohydric alcohols and preferably ethanol, low-molecular weight polyhydric alcohols, glycols, and glycerol, and mixtures thereof. In a preferred embodiment, the hydrophilic component comprises a pharmaceutically acceptable monohydric or polyhydric alcohol.

A surface treatment agent can be chemically immobilized or adsorbed onto the rubber substrate. Chemical linkage or immobilization of surface-treatment agents to a substrate differs from adsorption in that surface treated material has a more uniformly chemically bound reaction product.

For chemical linkage or immobilization, a water-soluble compound having a lipophilic or hydrophilic moiety absorbed onto substrate surface may create the reaction. With the addition of a water-soluble salt of a polyvalent metal for example, a chemical bond can be produced. The reaction product provides a chemical immobilized treatment onto the surface of the particles of the substrate, or a chemically immobilized substrate surface treatment. In contrast, a simple coating of a surface-active agent absent chemical immobilization renders a functional layer, which is absorbed onto the surface of the substrate.

In order to facilitate or enhance linkage or immobilization of surface-treatment agents to substrate, a water-soluble compound having a lipophilic or hydrophilic moiety being absorbed onto the surface of the substrate may create a reaction. As a non-limiting example, addition of a water-soluble salt of a polyvalent metal, such as magnesium, calcium, barium, aluminum, titanium, zinc or a zirconium salt (e.g., zirconium sulfate or chloride), or an alkaline salt, such as a sodium, potassium, lithium, ammonium, or an amine salt, can produce a chemical linkage. The reaction provides a surface-treatment agent chemically immobilized onto the surface of the substrate particle. In contrast, coating a substrate with a surface-treatment agent involves absorbing the surface-treatment agent onto the surface of the substrate.

Surface-treatment agents typically have one or more reactive groups, such as a hydrophilic moiety (e.g., a carboxyl group, a phosphorous group, a sulfur group, a silanol group or a silane group) or a hydrophobic moiety (e.g., a hydrocarbon, a dialkyl(CH3-, C2H5-) polysiloxane, perfluoroalkyl, etc.) in their structure. Surface-treatment agents may or may not contain one or more hydroxyl groups or alkylene oxide moieties, such as ethylene oxide or propylene oxide. Those having hydroxy groups in their structure and hydrophilic characteristics can be delivered after completing the reaction onto the surface. Where there are two or more surface-treatment agents (e.g., first, second, third, fourth, fifth, etc., surface-treatment agents), the surface treatment agents can have a hydrophilic moiety (e.g., two, three, four, five, etc., or more, hydrophilic moieties), a hydrophobic moiety (e.g., two, three, four, five, etc., or more, hydrophobic moieties), or a combination of a hydrophilic moiety and a hydrophobic moiety (e.g., one hydrophilic moiety and a hydrophobic moiety, two hydrophilic moieties and one hydrophobic moiety, two hydrophobic moieties and one hydrophilic moiety, three hydrophilic moieties and one hydrophobic moiety, two hydrophilic moieties and two hydrophobic moieties, three hydrophobic moieties and one hydrophilic moiety, etc.). A first or second surface-treatment agent can be devoid of one or more hydroxyl groups and/or alkylene oxide moieties.

Non-limiting examples of surface treatment agents include acyl collagens, ether carboxylic acids, lactates (e.g., lactic acid), gluconates (e.g., gluconic acid), galacturonic acid, glucarolactone, gallic acid, glucoheptanoic acid, amino acids (such as thereonine and serine) and their salts, acyl amino acids (such as acylglutamates, acylsarcosinates, acylglycinates, and acylalaninates), silanes, 12-hydroxystearic acid, laurylamidobetane, stearyl amphoacetate, lauryl amphopropionate, stearyl amphopropionate, fatty acids and their salts, glycerol phosphate esters (such as lecithin) and polyethylenes with free carboxylic acids.

Examples of anionic surface treatment agents (surfactants) include soaps (fatty acids/alkyl carboxylic acids salt), hydroxy fatty acids, alkyl sulfate, alkyl ether phosphate, polyoxyalkylene alkyl ether sulfate, polyoxyalkylene alkyl ether carboxylate, alkylether phosphate, acyl N-methyl taurate, N-acylamino acid salts (glutamate, sarcosinate, alaninate, glycinate, .beta.-alaninate), acyl peptides (acyl collagen, acyl silk protein), sodium cocoate, stearic acid, iso-stearic acid, potassium palmitate, sodium laurate, 12-hydroxystearic acid, sodium lauryl sulfate, sodium myristyl phosphate, sodium myristoyl sarcosinate, sodium polyoxyethylene lauryl sulfate, polyoxyethylene myristyl carboxylate, potassium myristate, zinc gluconate, isostearyl sebacic acid, sodium myristoyl taurate, disodium stearoyl glutamate, disodium cocoyl glutamate, arginine lauryl glycinate, sodium dilauramidoglutamide lysine.

Further, the surfactant can be an ionic polymeric surfactant, nonionic polymeric surfactant, polymeric surfactant, anionic polymeric surfactant, or zwitterionic polymeric surfactant. Examples of polymeric surfactants include, but are not limited to, a graft copolymer of a poly(methyl methacrylate) backbone with multiple (at least one) polyethylene oxide (PEO) side chain, polyhydroxystearic acid, an alkoxylated alkyl phenol formaldehyde condensate, a polyalkylene glycol modified polyester with fatty acid hydrophobes, a polyester, semi-synthetic derivatives thereof, or combinations thereof.

In another embodiment, suitable surface active agents or surfactants, are amphipathic molecules that consist of a non-polar hydrophobic portion, usually a straight or branched hydrocarbon or fluorocarbon chain containing 8-18 carbon atoms, attached to a polar or ionic hydrophilic portion. The hydrophilic portion can be nonionic, ionic or zwitterionic. The hydrocarbon chain interacts weakly with the water molecules in an aqueous environment, whereas the polar or ionic head group interacts strongly with water molecules via dipole or ion-dipole interactions. Based on the nature of the hydrophilic group, surfactants are classified into anionic, cationic, zwitterionic, nonionic and polymeric surfactants.

In another embodiment, suitable surfactants include, but are not limited to, ethoxylated nonylphenol comprising 9 to 10 units of ethyleneglycol, ethoxylated undecanol comprising 8 units of ethyleneglycol, polyoxyethylene (20) sorbitan monolaurate, polyoxyethylene (20) sorbitan monopalmitate, polyoxyethylene (20) sorbitan monostearate, polyoxyethylene (20) sorbitan monooleate, sorbitan monolaurate, sorbitan monopalmitate, sorbitan monostearate, sorbitan monooleate, ethoxylated hydrogenated ricin oils, sodium laurylsulfate, a diblock copolymer of ethyleneoxyde and propyleneoxyde, Ethylene Oxide-Propylene Oxide Block Copolymers, and tetra-functional block copolymers based on ethylene oxide and propylene oxide, Glyceryl monoesters, Glyceryl caprate, Glyceryl caprylate, Glyceryl cocate, Glyceryl erucate, Glyceryl hydroxysterate, Glyceryl isostearate, Glyceryl lanolate, Glyceryl laurate, Glyceryl linolate, Glyceryl myristate, Glyceryl oleate, Glyceryl PABA, Glyceryl palmitate, Glyceryl ricinoleate, Glyceryl stearate, Glyceryl thighlycolate, Glyceryl dilaurate, Glyceryl dioleate, Glyceryl dimyristate, Glyceryl disterate, Glyceryl sesuioleate, Glyceryl stearate lactate, Polyoxyethylene cetyl/stearyl ether. Polyoxyethylene cholesterol ether, Polyoxyethylene laurate or dilaurate, Polyoxyethylene stearate or distearate, polyoxyethylene fatty ethers, Polyoxyethylene lauryl ether, Polyoxyethylene stearyl ether, polyoxyethylene myristyl ether, a steroid, Cholesterol, Betasitosterol, Bisabolol, fatty acid esters of alcohols, isopropyl myristate, Aliphati-isopropyl n-butyrate, Isopropyl n-hexanoate, Isopropyl n-decanoate, Isoproppyl palmitate. Octyldodecyl myristate, alkoxylated alcohols, alkoxylated acids, alkoxylated amides, alkoxylated sugar derivatives, alkoxylated derivatives of natural oils and waxes, polyoxyethylene polyoxypropylene block copolymers, nonoxynol-14, PEG-8 laurate, PEG-6 Cocoamide, PEG-20 methylglucose sesquistearate. PEG40 lanolin. PEG-40 castor oil, PEG-40 hydrogenated castor oil, polyoxyethylene fatty ethers, glyceryl diesters, polyoxyethylene stearyl ether, polyoxyethylene myristyl ether, and polyoxyethylene lauryl ether, glyceryl dilaurate, glyceryl dimystate, glyceryl distearate, semi-synthetic derivatives thereof, or mixtures thereof.

In another embodiment, suitable surfactants include, but are not limited to, non-ionic lipids, such as glyceryl laurate, glyceryl myristate, glyceryl dilaurate, glyceryl dimyristate, semi-synthetic derivatives thereof, and mixtures thereof.

In additional embodiments, the surfactant is a polyoxyethylene fatty ether having a polyoxyethylene head group ranging from about 2 to about 100 groups, or an alkoxylated alcohol having the structure R5-(OCH2CH2)y-OH, wherein R5 is a branched or unbranched alkyl group having from about 6 to about 22 carbon atoms and y is between about 4 and about 100, and preferably, between about 10 and about 100. Preferably, the alkoxylated alcohol is the species wherein R5 is a lauryl group and y has an average value of 23.

In a different embodiment, the surfactant is an alkoxylated alcohol, which is an ethoxylated derivative of lanolin alcohol. In another embodiment, the ethoxylated derivative of lanolin alcohol is laneth-10, which is the polyethylene glycol ether of lanolin alcohol with an average ethoxylation value of 10.

In another embodiment, suitable nonionic surfactants include, but are not limited to, an ethoxylated surfactant, an alcohol ethoxylated, an alkyl phenol ethoxylated, a fatty acid ethoxylated, a monoalkaolamide ethoxylated, a sorbitan ester ethoxylated, a fatty amino ethoxylated, an ethylene oxide-propylene oxide copolymer, Bis(polyethylene glycol bis[imidazoyl carbonyl]), nonoxynol-9, Bis(polyethylene glycol bis[imidazoyl carbonyl]), Brij® 35, Brij® 56, Brij® 72, Brij® 76, Brij® 92V. Brij® 97, Brij® 58P, Cremophor® EL, Decaethylene glycol monododecyl ether, N-Decanoyl-N-methylglucamine, n-Decyl alpha-D-glucopyranoside, Decyl beta-D-maltopyranoside, n-Dodecanoyl-N-methylglucamide, n-Dodecyl alpha-D-maltoside, n-Dodecyl beta-D-maltoside, n-Dodecyl beta-D-maltoside. Heptaethylene glycol monodecyl ether, Heptaethylene glycol monododecyl ether, Heptaethylene glycol monotetradecyl ether, n-Hexadecyl beta-D-maltoside, Hexaethylene glycol monododecyl ether, Hexaethylene glycol monohexadecyl ether, Hexaethylene glycol monooctadecyl ether, Hexaethylene glycol monotetradecyl ether, Igepal CA-630, Igepal CA-630, Methyl-6-O—(N-heptylcarbamoyl)-alpha-D-glucopyranoside. Nonaethylene glycol monododecyl ether, N—N—Nonanoyl-N-methylglucamine, Octaethylene glycol monodecyl ether, Octaethylene glycol monododecyl ether. Octaethylene glycol monohexadecyl ether, Octaethylene glycol monooctadecyl ether, Octaethylene glycol monotetradecyl ether, Octyl-beta-D-glucopyranoside, Pentaethylene glycol monodecyl ether, Pentaethylene glycol monododecyl ether, Pentaethylene glycol monohexadecyl ether. Pentaethylene glycol monohexyl ether, Pentaethylene glycol monooctadecyl ether, Pentaethylene glycol monooctyl ether, Polyethylene glycol diglycidyl ether, Polyethylene glycol ether W-1, Polyoxyethylene 10 tridecyl ether, Polyoxyethylene 100 stearate, Polyoxyethylene 20 isohexadecyl ether. Polyoxyethylene 20 oleyl ether. Polyoxyethylene 40 stearate, Polyoxyethylene 50 stearate, Polyoxyethylene 8 stearate, Polyoxyethylene bis(imidazolyl carbonyl), Polyoxyethylene 25 propylene glycol stearate. Saponin from Quillaja bark, Span® 20, Span® 40, Span® 60, Span® 65, Span® 80, Span® 85, Tergitol, Type 15-S-12, Tergitol, Type 15-S-30, Tergitol, Type 15-S-5, Tergitol, Type 15-S-7, Tergitol, Type 15-S-9, Tergitol, Type NP-10, Tergitol, Type NP-4, Tergitol, Type NP-40, Tergitol, Type NP-7, Tergitol, Type NP-9, Tergitol, Tergitol, Type TMN-10, Tergitol, Type TMN-6, Tetradecyl-beta-D-maltoside. Tetraethylene glycol monodecyl ether. Tetraethylene glycol monododecyl ether, Tetraethylene glycol monotetradecyl ether, Triethylene glycol monodecyl ether, Triethylene glycol monododecyl ether, Triethylene glycol monohexadecyl ether, Triethylene glycol monooctyl ether, Triethylene glycol monotetradecyl ether, Triton CF-21, Triton CF-32, Triton DF-12, Triton DF-16, Triton GR-5M, Triton QS-15, Triton QS-44, Triton X-100, Triton X-102, Triton X-15, Triton X-151, Triton X-200, Triton X-207, Triton® X-114, Triton® X-165, Triton® X-305, Triton® X-405, Triton® X-45, Triton® X-705-70, TWEEN® 20, TWEEN® 21, TWEEN® 40, TWEEN® 60, TWEEN® 61, TWEEN® 65, TWEEN® 80, TWEEN® 81, TWEEN® 85, Tyloxapol, n-Undecyl beta-D-glucopyranoside, semi-synthetic derivatives thereof, or combinations thereof.

In addition, the nonionic surfactant can be a poloxamer. Poloxamers are polymers made of a block of polyoxyethylene, followed by a block of polyoxypropylene, followed by a block of polyoxyethylene. The average number of units of polyoxyethylene and polyoxypropylene varies based on the number associated with the polymer. For example, the smallest polymer, Poloxamer 101, consists of a block with an average of 2 units of polyoxyethylene, a block with an average of 16 units of polyoxypropylene, followed by a block with an average of 2 units of polyoxyethylene. Poloxamers range from colorless liquids and pastes to white solids. In cosmetics and personal care products, Poloxamers are used in the formulation of skin cleansers, bath products, shampoos, hair conditioners, mouthwashes, eye makeup remover and other skin and hair products. Examples of Poloxamers include, but are not limited to, Poloxamer 101, Poloxamer 105, Poloxamer 108, Poloxamer 122, Poloxamer 123, Poloxamer 124. Poloxamer 181, Poloxamer 182, Poloxamer 183, Poloxamer 184, Poloxamer 185, Poloxamer 188, Poloxamer 212, Poloxamer 215, Poloxamer 217, Poloxamer 231, Poloxamer 234, Poloxamer 235, Poloxamer 237, Poloxamer 238, Poloxamer 282, Poloxamer 284, Poloxamer 288, Poloxamer 331, Poloxamer 333, Poloxamer 334, Poloxamer 335, Poloxamer 338, Poloxamer 401, Poloxamer 402, Poloxamer 403, Poloxamer 407, Poloxamer 105 Benzoate, and Poloxamer 182 Dibenzoate.

In another embodiment, suitable surfactants include, but are not limited to, a quarternary ammonium compound, an alkyl trimethyl ammonium chloride compound, a dialkyl dimethyl ammonium chloride compound, a halogen-containing compound, such as cetylpyridinium chloride, Benzalkonium chloride, Benzalkonium chloride, Benzyldimethylhexadecylammonium chloride, Benzyldimethyltetradecylammonium chloride, Benzyldodecyldimethylammonium bromide, Benzyltrimethylammonium tetrachloroiodate, Dimethyldioctadecylammonium bromide, Dodecylethyldimethylammonium bromide, Dodecyltrimethylammonium bromide, Dodecyltrimethylammonium bromide, Ethylhexadecyldimethylammonium bromide, Girard's reagent T, Hexadecyltrimethylammonium bromide, Hexadecyltrimethylammonium bromide, N,N′,N′-Polyoxyethylene(10)-N-tallow-1,3-diaminopropane, Thonzonium bromide, Trimethyl(tetradecyl)ammonium bromide, 1,3,5-Triazine-1,3,5(2H,4H,6H)-triethanol, 1-Decanaminium, N-decyl-N,N-dimethyl-, chloride, Didecyl dimethyl ammonium chloride, 2-(2-(p-(Diisobutyl)cresosxy)ethoxy)ethyl dimethyl benzyl ammonium chloride, 2-(2-(p-(Diisobutyl)phenoxy)ethoxy)ethyl dimethyl benzyl ammonium chloride, Alkyl 1 or 3 benzyl-1-(2-hydroxethyl)-2-imidazolinium chloride, Alkyl bis(2-hydroxyethyl)benzyl ammonium chloride, Alkyl demethyl benzyl ammonium chloride, Alkyl dimethyl 3,4-dichlorobenzyl ammonium chloride (100% C12), Alkyl dimethyl 3,4-dichlorobenzyl ammonium chloride (50% C14, 40% C12, 10% C16), Alkyl dimethyl 3,4-dichlorobenzyl ammonium chloride (55% C14, 23% C12, 20% C16), Alkyl dimethyl benzyl ammonium chloride, Alkyl dimethyl benzyl ammonium chloride (100% C14), Alkyl dimethyl benzyl ammonium chloride (100% C16), Alkyl dimethyl benzyl ammonium chloride (41% C14, 28% C12), Alkyl dimethyl benzyl ammonium chloride (47% C12, 18% C14), Alkyl dimethyl benzyl ammonium chloride (55% C16, 20% C14), Alkyl dimethyl benzyl ammonium chloride (58% C14, 28% C16), Alkyl dimethyl benzyl ammonium chloride (60% C14, 25% C12), Alkyl dimethyl benzyl ammonium chloride (61% C11, 23% C14), Alkyl dimethyl benzyl ammonium chloride (61% C12, 23% C14), Alkyl dimethyl benzyl ammonium chloride (65% C12, 25% C14). Alkyl dimethyl benzyl ammonium chloride (67% C12, 24% C14), Alkyl dimethyl benzyl ammonium chloride (67% C12, 25% C14), Alkyl dimethyl benzyl ammonium chloride (90% C14, 5% C12), Alkyl dimethyl benzyl ammonium chloride (93% C14, 4% C12), Alkyl dimethyl benzyl ammonium chloride (95% C16, 5% C18), Alkyl didecyl dimethyl ammonium chloride, Alkyl dimethyl benzyl ammonium chloride (C12-16), Alkyl dimethyl benzyl ammonium chloride (C12-18), dialkyl dimethyl benzyl ammonium chloride, Alkyl dimethyl dimethybenzyl ammonium chloride, Alkyl dimethyl ethyl ammonium bromide (90% C14, 5% C16, 5% C12), Alkyl dimethyl ethyl ammonium bromide (mixed alkyl and alkenyl groups as in the fatty acids of soybean oil), Alkyl dimethyl ethylbenzyl ammonium chloride, Alkyl dimethyl ethylbenzyl ammonium chloride (60% C14), Alkyl dimethyl isopropylbenzyl ammonium chloride (50% C12, 30% C14, 17% C16, 3% C18), Alkyl trimethyl ammonium chloride (58% C18, 40% C16, 1% C14, 1% C12), Alkyl trimethyl ammonium chloride (90% C18, 10% C16), Alkyldimethyl(ethylbenzyl) ammonium chloride (C12-18), Di-(C8-10)-alkyl dimethyl ammonium chlorides, Dialkyl dimethyl ammonium chloride, Dialkyl methyl benzyl ammonium chloride, Didecyl dimethyl ammonium chloride, Diisodecyl dimethyl ammonium chloride, Dioctyl dimethyl ammonium chloride, Dodecyl bis(2-hydroxyethyl) octyl hydrogen ammonium chloride, Dodecyl dimethyl benzyl ammonium chloride, Dodecylcarbamoyl methyl dimethyl benzyl ammonium chloride, Heptadecyl hydroxyethylimidazolinium chloride, Hexahydro-1,3,5-tris(2-hydroxyethyl)-s-triazine, Myristalkonium chloride (and) Quat RNIUM 14, N,N-Dimethyl-2-hydroxypropylammonium chloride polymer, n-Tetradecyl dimethyl benzyl ammonium chloride monohydrate, Octyl decyl dimethyl ammonium chloride, Octyl dodecyl dimethyl ammonium chloride, Octyphenoxyethoxyethyl dimethyl benzyl ammonium chloride, Oxydiethylenebis(alkyl dimethyl ammonium chloride), Trimethoxysily propyl dimethyl octadecyl ammonium chloride, Trimethoxysilyl quats, Trimethyl dodecylbenzyl ammonium chloride, semi-synthetic derivatives thereof, and combinations thereof.

In another embodiment, suitable halogen-containing compounds include, but are not limited to, cetylpyridinium halides, cetyltrimethylammonium halides, cetyldimethylethylammonium halides, cetyldimethylbenzylammonium halides, cetyltributylphosphonium halides, dodecyltrimethylammonium halides, or tetradecyltrimethylammonium halides. In some particular embodiments, suitable halogen containing compounds comprise, but are not limited to, cetylpyridinium chloride (CPC), cetyltrimethylammonium chloride, cetylbenzyldimethylammonium chloride, cetylpyridinium bromide (CPB), cetyltrimethylammonium bromide (CTAB), cetyidimethylethylammonium bromide, cetyltributylphosphonium bromide, dodecyltrimethylammonium bromide, and tetrad ecyltrimethylammonium bromide. In particularly preferred embodiments, the halogen-containing compound is CPC, although the compositions of the present invention are not limited to formulation with a particular containing compound.

In another embodiment, suitable anionic surfactants include, but are not limited to, a carboxylate, a sulphate, a sulphonate, a phosphate, chenodeoxycholic acid, chenodeoxycholic acid sodium salt, cholic acid, ox or sheep bile, Dehydrocholic acid, Deoxycholic acid, Deoxycholic acid, Deoxycholic acid methyl ester, Digitonin, Digitoxigenin, N,N-Dimethyldodecylamine N-oxide. Docusate sodium salt, Glycochenodeoxycholic acid sodium salt, Glycocholic acid hydrate, synthetic, Glycocholic acid sodium salt hydrate, synthetic, Glycodeoxycholic acid monohydrate, Glycodeoxycholic acid sodium salt, Glycolithocholic acid 3-sulfate disodium salt. Glycolithocholic acid ethyl ester, N-Lauroylsarcosine sodium salt, N-Lauroylsarcosine solution. N-Lauroylsarcosine solution, Lithium dodecyl sulfate, Lithium dodecyl sulfate, Lithium dodecyl sulfate, Lugol solution, Niaproof 4, Type 4,1-Octanesulfonic acid sodium salt, Sodium 1-butanesulfonate, Sodium 1-decanesulfonate, Sodium 1-decanesulfonate, Sodium 1-dodecanesulfonate, Sodium 1-heptanesulfonate anhydrous, Sodium 1-heptanesulfonate anhydrous. Sodium 1-nonanesulfonate, Sodium 1-propanesulfonate monohydrate, Sodium 2-bromoethanesulfonate, Sodium cholate hydrate, Sodium choleate, Sodium deoxycholate, Sodium deoxycholate monohydrate, Sodium dodecyl sulfate, Sodium hexanesulfonate anhydrous, Sodium octyl sulfate, Sodium pentanesulfonate anhydrous, Sodium taurocholate, Taurochenodeoxycholic acid sodium salt, Taurodeoxycholic acid sodium salt monohydrate, Taurohyodeoxycholic acid sodium salt hydrate, Taurolithocholic acid 3-sulfate disodium salt, Tauroursodeoxycholic acid sodium salt, Trizma® dodecyl sulfate, TWEEN® 80, Ursodeoxycholic acid, semi-synthetic derivatives thereof, and combinations thereof.

In another embodiment, suitable zwitterionic surfactants include, but are not limited to, an N-alkyl betaine, lauryl amindo propyl dimethyl betaine, an alkyl dimethyl glycinate, an N-alkyl amino propionate, CHAPS, minimum 98% (TLC), CHAPS, minimum 98% (TLC), CHAPS, for electrophoresis, minimum 98% (TLC), CHAPSO, minimum 98%, CHAPSO, CHAPSO, for electrophoresis, 3-(Decyldimethylammonio)propanesulfonate inner salt, 3-Dodecyldimethylammonio)propanesulfonate inner salt, 3-(Dodecyldimethylammonio)propanesulfonate inner salt, 3-(N,N-Dimethylmyristylammonio)propanesulfonate, 3-(N,N-Dimethyloctadecylammonio)propanesulfonate, 3-(N,N-Dimethyloctylammonio)propanesulfonate inner salt, 3-(N,N-Dimethylpalmitylammonio)propanesulfonate, semi-synthetic derivatives thereof, and combinations thereof.

In some embodiments of the invention, the coating composition comprises a surfactant, and the concentration of the surfactant is less than about 5.0% and greater than about 0.001%. In yet another embodiment of the invention, the coating composition comprises a surfactant, and the concentration of the surfactant is selected from the group consisting of less than about 5%, less than about 4.5%, less than about 4.0%, less than about 3.5%, less than about 3.0%, less than about 2.5%, less than about 2.0%, less than about 1.5%, less than about 1.0%, less than about 0.90%, less than about 0.80%, less than about 0.70%, less than about 0.60%, less than about 0.50%, less than about 0.40%, less than about 0.30%, less than about 0.20%, or less than about 0.10%. Further, the concentration of the agent in the coating composition is greater than about 0.002%, greater than about 0.003%, greater than about 0.004%, greater than about 0.005%, greater than about 0.006%, greater than about 0.007%, greater than about 0.008%, greater than about 0.009%, greater than about 0.010%, or greater than about 0.001%. In one embodiment, the concentration of the agent in the coating composition is less than about 5.0% and greater than about 0.001%.

In additional particular embodiments in which there are two or more surface treatment agents, one or more optionally chemically immobilized onto the surface of a pigment, a first and second surface treatment agent can have a relatively high hydrophilic-lipophilic balance (HLB) and a second surface treatment agent can have a relatively low HLB. In an exemplary embodiment, a first surface-treatment agent has a hydrophilic-lipophilic balance of about 10 or higher (e.g., 11, 12, 13, 14, 15, 16, 17, 18, etc.) and contains at least one functional group selected from the group consisting of a carboxyl group or a salt of a carboxyl group, a phosphorous group or a salt of a phosphorous group, a sulfur group or a salt of a sulfur group, and a silane group; and a second surface-treatment agent has a hydrophilic-lipophilic balance of about 9 or lower (e.g., 8, 7, 6, 5, 4, 3, etc.) and contains at least one functional group; and the difference in the hydrophilic-lipophilic balance values between the first and the second surface-treatment agent is at least about 5 (e.g., 6, 7, 8, 9, 10, 11, 12, 13, 14, 15, 16, 17, 18, 19, etc.). In various aspects, a functional group is selected from a carboxyl group or a salt of a carboxyl group, a phosphorous group or a salt of a phosphorous group, a sulfur group or a salt of a sulfur group. In another embodiment, a first surface-treatment agent has a hydrophilic-lipophilic balance ranging from about 14 to 18. In an additional embodiment, a second surface-treatment agent has a hydrophilic-lipophilic balance ranging from about 1 to 4. In particular aspects, a first surface-treatment agent contains one or more hydroxyl groups or alkylene oxide moieties (e.g., an ethylene oxide moiety, a propylene oxide moiety, or a combination thereof).

If desired, additional surface-treatment agents may also be added. For example, more than one hydrophilic surface treatment agent and more than one hydrophobic surface treatment agent may be used. Additional surface treatment agents can be adhered to the substrate to impart additional functionality of these surface treatment agents. The additional surface treatment agents need not be within the genera of first and second surface treatment agents described herein.

In another embodiment of the invention, the coating composition comprises at least one surfactant and at least one non-surfactant. The non-surfactant is a nonionic surfactant, such as a polysorbate (Tween), such as polysorbate 80 or polysorbate 20. In one embodiment, the non-ionic surfactant is present in a concentration of about 0.05% to about 7.0%, or the non-ionic surfactant is present in a concentration of about 0.3% to about 4%. In yet another embodiment of the invention, the coating composition comprises a surfactant present in a concentration of about 0.01% to about 2%, in combination with a nonionic surfactant.

In one embodiment of the invention, the coating composition comprises triethanolamine. In another embodiment, the coating composition comprises triethanolamine and a solvent. In another embodiment, the solvent is an alcohol. In another embodiment, the solvent is an alcohol is in an aqueous medium. In another embodiment, the coating composition comprises triethanolamine and isopropyl alcohol in an aqueous medium.

Examples of coatings are triethanolamine, propylene glycol, titanium dioxide and a variety of different flouro surfactants. In one embodiment, the surfactants are those that are biocompatible for use in aquatic weed control or in situations where some of the surfactant is likely to be introduce into ground water such as materials with trade names like Carbowet® 13-40, Cide Kick (d,1-limonene), Cygnet Plus (d,-limonene and related isomers), EnviroGem, Klucel, Plex Mate, Pluronics, SilEnergy (an organosilicone surfactant, polyalkyleneoxide modified polydimethyisloloxane and nonionic surfactants), Suretech 827 and 830, Triton.

In another embodiment, the surfactant is selected from ones that are biocompatible including NPE-based surfactants, POEA (polyethoxylated tallow amine), Agri-Dex, LI-700, R-11, Latron AG-98, and Latron AG-98 AG, surfactants in Glyphosate, and Polyglycol 26-2 in Picloram. Other adjuvants/surfactants include the following:

Surfactants including Ethoxylated fatty amines (Cationic) such as Entry™ II (Monsanto Company) and POEA—Roundup® has 15 percent POEA. Alkylphenol ethoxylate-based surfactants (non-ionic) such as R-11® Spreader Activator (Wilbur-Ellis Company), Activator 90 (Loveland Industries), X-77® (Loveland Industries), Latron AG-98™ (N) (Dow AgroSciences LLC), Latron AG-98™ (Dow AgroSciences LLC), Cide-Kick®, and Cide-Kick® II™ (Brewer International). These surfactants usually include an alcohol as a solvent (isopropanol (X-77®, AG-98™), butanol (R-11®, AG-98™ (N)), glycol (AG-98™ (N), Activator 90)), a silicone defoamer (polydimethylsiloxane), and water.

Alcohol ethoxylate-based surfactants (non-ionic) such as Activator N.F. (Loveland Industries).

Silicone-Based Surfactants: Also known as organosilicones, these are increasing in popularity because of their superior spreading ability. This class contains a polysiloxane chain. Some of these are a blend of non-ionic surfactants (NIS) and silicone while others are entirely silicone. Examples include SylgardP 309 (Wilbur-Ellis Company)—silicones, Freeway® (Loveland Industries)—silicone blend, Dyne-Amic®(Helena Chemical Company)—silicone blend. Silwet L-77® (Loveland and Helena)—silicones. Blends normally include an alcohol ethoxylate, a defoamer, and propylene glycol.

Oils: Oil adjuvants are made up of either petroleum, vegetable, or methylated vegetable or seed oils plus an emulsifier for dispersion in water.

Vegetable Oils: The methylated seed oils are formed from common seed oils, such as canola, soybean, or cotton. These are comparable in performance to crop oil concentrates. In addition, silicone-seed oil blends are also available that take advantage of the spreading ability of the silicones and the penetrating characteristics of the seed oils.

The U.S. Food and Drug Administration (FDA) considers methyl and ethyl esters of fatty acids produced from edible fats and oils to be food grade additives (CFR 172.225). Because of the lack of exact ingredient statements on these surfactants, it is not always clear whether the oils that are used in them meet the U.S. FDA standard. These include: MSO® Concentrate Methylated Seed Oil (Loveland Industries), Hasten®(Wilbur-Ellis Company), surfactant in Pathfinder® II (a triclopyr formulation), improved JLB Oil Plus (Brewer International), Cide-Kick and Cide-Kick II (Brewer International), and blends of vegetable oils and silicone-based surfactants, Syl-Tac™ (Wilbur-Ellis Company), Phase™ (Loveland Industries)

Crop Oils and Crop Oil Concentrates: These are normally derivatives of paraffin-based petroleum oil. Crop oils are generally 95 to 98 percent oil with 1 to 2 percent surfactant/emulsifier. Crop oil concentrates are a blend of crop oils (80 to 85 percent) and a nonionic surfactant (15 to 20 percent). The purpose of the nonionic surfactant in this mixture is to emulsify the oil in the spray solution and lower the surface tension of the overall spray solution. See: kerosene (found in the triclopyr formulation Garlon 4), Agri-Dex® (Helena Chemical Co. or Setre Chemical Co.) and Red-Top Mor-Act® (Wilbur-Ellis Company)

Special Purpose or Utility Adjuvants: The special purpose or utility adjuvants are used to offset or correct certain conditions associated with mixing and application such as impurities in the spray solution, extreme pH levels, and drift. These adjuvants include acidifiers, buffering agents, water conditioners, anti-foaming agents, compatibility agents, and drift control agents. The pH of most solutions is not high or low enough for significant chemical breakdown in the spray tank. In another embodiment, pH-reducing adjuvants (such as LI-700® Surfactant Penetrant Acidifier) may be used.

### Water-Soluble Polyvalent Metal Compound

In one embodiment, the surface-treatment agent comprises a water-soluble polyvalent metal compound (for example, ammonium zirconyl carbonate etc.) described later and optionally water. If necessary, the coating liquid may further comprise other ingredients. In another embodiment, the compositions may further comprise one or more additional surface treatment agents as described above.

The water-soluble polyvalent metal compound used in the invention is preferably a trivalent or higher-valent metal compound. The metal compound may be, for example, a water-soluble salt of a metal selected from calcium, barium, manganese, copper, cobalt, nickel, aluminum, iron, zinc, zirconium, chromium, magnesium, tungsten and molybdenum.

Examples of such compounds include calcium acetate, calcium chloride, calcium formate, calcium sulfate, calcium butyrate, barium acetate, barium sulfate, barium phosphate, barium oxalate, barium naphthoresorcin carboxylate, barium butyrate, manganese chloride, manganese acetate, manganese formate.2H2O, ammonium manganese sulfate.6H2O, cupper(II) chloride, cupper(II) ammonium chloride.2H2O, copper sulfate, copper(II) butyrate, copper oxalate, copper phthalate, copper citrate, copper gluconate, copper naphthenate, cobalt chloride, cobalt thiocyanate, cobalt sulfate, cobalt(II) acetate, cobalt napthenate, nickel sulfate-6H2O, nickel chloride.6H2O, nickel acetate.4H2O, ammonium nickel sulfate.6H2O, dinickel amidosulfate.4H2O, nickel sulfaminate, nickel 2-ethyl hexanoate, aluminum sulfate, aluminum sulfite, aluminum thiosulfate, polyaluminum chloride, aluminum nitrate-9H2O, aluminum chloride.6H2O, aluminum acetate, aluminum lactate, basic aluminum thioglycolate, ferrous bromide, ferrous chloride, ferric chloride, ferrous sulfate, ferric sulfate, iron(III) nitrate, iron(III) lactate.3H2O, iron(III) ammonium trioxalate.3H2O, zinc bromide, zinc chloride, zinc nitrate.6H2O, zinc sulfate, zinc acetate, zinc lactate, zirconyl acetate, zirconyl chloride, zirconyl oxide chloride.8H2O, zirconyl hydroxychloride, chrome acetate, chrome sulfate, magnesium acetate, magnesium oxalate, magnesium sulfate, magnesium chloride.6H2O, magnesium citrate.9H2O, sodium phosphotungstate, tungsten sodium citrate, 12-tungustophosphoric acid.nH2O, 12-tungstosilicic acid-26H2O, molybdenum chloride, and 12-molybdophoshoric acid.nH2O. Two or more water-soluble polyvalent metal compounds may be used in combination. In the invention, the water-soluble polyvalent metal compound has a solubility in water of 1 wt % or more at 20 degree C.

The water-soluble polyvalent metal compound is preferably a compound comprising aluminum or a metal (for example, zirconium, titanium) of group 4A of Periodic Table. The water-soluble polyvalent metal compound is particularly preferably a water-soluble aluminum compound. The water-soluble aluminum compound may be an inorganic aluminum salt, and examples thereof include aluminum chloride and hydrates thereof, aluminum sulfate and hydrates thereof, and aluminum alum. The water-soluble aluminum compound may also be a basic polyaluminum hydroxide compound, which is an inorganic aluminum-containing cationic polymer.

In an additional embodiment, metal agents may be used as the surface-treatment agent for treating the surface of the hydrophobic surfacing materials. In one embodiment, the polyvalent metals or metal complexes that cross-link individual polymer molecules to each other. The amount of metal cross-linking agents employed will vary depending upon the amount of water-borne polymer and the acid number of the polymer. In one embodiment, suitable polyvalent metals include zirconium, titanium, hafnium, chromium, zinc, aluminum, or a mixture of any two or more thereof. In one embodiment, zirconium is especially well suited as a metal cross-linking agent.

The inorganic metal used in the invention refers to a metal compound, which has solubility with respect to a surfactant and is capable of forming a metal ion. The metal compound is preferably a salt or a complex, and more preferably a salt or complex of a polyvalent metal.

Specific examples of the inorganic oxide include salts or complexes of a metal selected from the group consisting of magnesium, aluminum, calcium, scandium, titanium, vanadium, chromium, manganese, iron, cobalt, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten, and bismuth.

Specifically, examples thereof include calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, copper II) chloride, ammonium copper(II) chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum alum, basic polyaluminum hydroxide, aluminum sulfite, aluminum thiosulfate, polyaluminum chloride, aluminum nitrate nonahydrate, aluminum chloride hexahydrate, iron(II) bromide, iron(II) chloride, iron(III) chloride, iron(II) sulfate, iron(III) sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, ammonium zirconium carbonate, zirconyl stearate, zirconyl octylate, zirconyl nitrate, zirconium oxychloride, zirconium hydroxychloride, chromium acetate, chromium sulfate, magnesium sulfate, magnesium chloride hexahydrate, magnesium citrate nonahydrate, sodium phosphorustungstate, sodium tungsten citrate, 12 tungstophosphoric acid n-hydrate, 12 tungstosilicic acid 26 hydrate, molybdenum chloride, 12 molybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, and bismuth nitrate.

In one embodiment, the inorganic oxide used in the present invention is a compound including aluminum, a compound including titanium, a compound including zirconium, or a metal compound including an element belonging to Group IIIB of the periodic table.

In one embodiment, the metal agent is a salt or complex of ammonia, acetate, propionate, sulfate, carbonate, nitrate, phosphate, tartrate, acetylacetonate, oxide, or a mixture of any two or more thereof. In one embodiment, the metal cross-linking agents include ammonium zirconium carbonate, zirconium acetylacetonate, zirconium acetate, zirconium carbonate, zirconium sulfate, zirconium phosphate, potassium zirconium carbonate, zirconium sodium phosphate, zirconium tartrate, zinc oxide, and other combinations of the above polyvalent metals and counter ions. Mel Chemicals' Bacote (ammonium zirconium carbonate) and Zirmel (potassium zirconium carbonate) products are well established formulations. Similarly, organic titanates such as titanium acetylacetonate and titanium lactate chelate can be used.

The zirconium (Zr) complex salt is a complex salt that forms the anionic Zr complex ion in a solution or in a surfactant.

The anionic Zr complex ion preferably has an anionic ligand. Examples of the anionic ligand include CO32- (carbonato), OH— (hydroxo), and the like. The anionic Zr complex ion may be [Zr(CO3)2(OH)2]2-. A counter ion in the Zr complex salt may be an alkali metal ion or a quaternary ammonium ion. Examples of the alkali metal ion include sodium ion (Na+), lithium ion (Li+), potassium ion (K+), and the like. Examples of the quaternary ammonium ion include ammonium ion (NH4+), tetramethylammonium ion, tetraethylammonium ion, tetrabutylammonium ion, and the like. Examples of the Zr complex salt include K2[Zr(CO3)2(OH)2], (NH4)2[Zr(CO3)2(OH)2], and the like. For example, commercially available Zr complex salt may be used. Examples of the commercially available Zr complex salt include “ZIRMEL 1000” and “BAYCOAT 20” (Nippon Light Metal Co., Ltd.); and the like.

The solid content of the Zr complex salt relative to the total amount of the water-based surfactant is, for example, in the range from about 0.1 wt % to about 80 wt %, from about 0.1 wt % to about 60 wt %, from about 0.1 wt % to about 25 wt %, from about 0.1 wt % to about 18 wt %, from about 0.1 wt % to about 10 wt %, and from about 0.1 wt % to about 4 wt %.

The amount of the metal cross-linking agent used in inventive compositions will vary with the nature of the particle and polyvalent metal.

In accordance with one embodiment, the invention is directed towards an aqueous surfactant composition comprising at least one of dispersed polyvalent metal oxide particle dispersion, wherein the surfactant composition has a pH of greater than 4 and the polyvalent metal oxide particles have a negative zeta potential at the pH of the composition. The size of the metal oxide particles preferably is less than 100 nm, more preferably less than about 50 nm, and may have a surface treatment that maintains the zeta potential in the desired range.

As an alternative approach to adding polyvalent metal ions in salt form is the use of a form of the metal in the form of metal oxide particles may be employed to release the metal ion at an adequate level, where polyvalent metal oxide particles are employed which have a negative zeta potential at the pH of the surfactant composition.

Most particles in an aqueous environment have some surface charge that can cause particle repulsion and stabilize the particles from flocculation or agglomeration if the charge is large enough. Charged particles in an aqueous environment are often characterized by their movement in an electric field or electrokinetic behavior. Particles with a charged surface will attract ions of the opposite charge to the surface to form a double layer of charge that dissipates with distance into the surrounding bulk medium. This apparent charge is dependent on both the nature of the particle surface and the properties of the surrounding medium including pH, viscosity, and salt concentration.

The surfactants of the present invention are aqueous-based surfactants. By aqueous-based it is meant that the surfactant comprises mainly water as the carrier medium for the remaining surfactant components. In a preferred embodiment, the surfactants of the present invention comprise at least about 50-weight percent water. Surfactant-based surfactants are defined as surfactants containing at least a dispersion of water-insoluble surfactant particles.

The surfactant compositions of the present invention contain low levels, relative to the colorant and polymer levels, of dispersions of metal oxides such as alumina and zinc oxide that have a negative zeta potential at a pH of greater than 4. These metal oxide dispersions may include a surface treatment or addenda such as a surfactant or polymer that provides a stable negative zeta potential to the particles over the pH range of interest. These metal oxide dispersions can be added to surfactant compositions containing negatively charged surfactants and polymers with no significant destabilizing interaction. Preferred levels of addition of such metal oxide particles is from 10 to 10,000 ppm, more preferably from 50 to 1000 ppm. While higher levels within such ranges are possible, generally levels below about 500 ppm are sufficient.

It is beneficial that the particles are small enough so that they have a high surface area. The particle size preferably should be less than 100 nm, and more preferably less than or equal to about 50 nm.

Polyvalent metal oxide particles employed in the invention may contain aluminum or other polyvalent metal ions that can form metal oxide bonds. Aluminum ion in particular has been found to be effective to inhibit aqueous dissolution of silicon oxide-based glass. Other polyvalent metal ions such as zinc, zirconium, hafnium, and titanium may also be useful. The surfactants of the present invention preferably comprise surfactant particles dispersed in the aqueous carrier.

As noted, the surfactants of the invention may comprise self-dispersing surfactants that are dispersible without the use of a dispersant. Surfactants of this type are those that have been subjected to a surface treatment such as oxidation/reduction, acid/base treatment, or functionalization through coupling chemistry. The surface treatment can render the surface of the surfactant with anionic, cationic or non-ionic groups, as described above.

The surfactant particles are preferably dispersed by a polymeric or small molecule dispersant in an amount sufficient to provide stability in the aqueous suspension and subsequent surfactant. The amount of dispersant relative to surfactant is a function of the desired particle size and related surface area of the fine particle dispersion. It is understood that the amount of dispersant and relative ratios of the monomer constituents of a polymeric dispersant can be varied to achieve the desired particle stability and surfactant firing performance for a given surfactant, as it is known that surfactants can vary in composition and affinity for a polymeric dispersant.

The surfactants used in the surfactant composition of the invention may be present in any effective amount, generally from 0.1 to 10% by weight, and preferably from 0.5 to 6% by weight, more preferably from 1 to 4% by weight.

Surfactant compositions useful in the invention can also comprise a humectant in order to achieve high frequency firing with low variability. Representative examples of humectants which may be employed in the present invention include; (1) triols, such as; glycerol, 1,2,6-hexanetriol, 2-ethyl-2-hydroxymethyl-propane diol, trimethylolpropane, alkoxylated triols, alkoxylated pentaerythritols, saccharides and sugar alcohols, (2) diols, such as ethylene glycol, diethylene glycol, triethylene glycol, propylene glycol, polyalkylene glycols having four or more alkylene oxide groups, 1,3-propane diol, 1,2-butane diol, 1,3-butane diol, 1,4-butane diol, 1,2-pentane diol, 1,5-pentanediol, 1,2-hexanediol, 1,6-hexane diol, 2-methyl-2,4-pentanediol, 1,2-heptane diol, 1,7-hexane diol, 2-ethyl-1,3-hexane diol, 1,2-octane diol, 2,2,4-trimethyl-1,3-pentane diol, 1,8-octane diol; and thioglycol, or a mixture thereof. Typical aqueous-based surfactant compositions useful in the invention may contain 2-25 weight percent humectant(s), more preferably from about 6-20% humectant, most preferably from about 8-15% humectant.

The surfactant compositions of the present may also include, in addition to the humectant, a water miscible co-solvent or penetrant. Representative examples of co-solvents used in the aqueous-based compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) lower mono- and di-alkyl ethers derived from the polyhydric alcohols; such as, ethylene glycol monomethyl ether, ethylene glycol monobutyl ether, ethylene glycol monoethyl ether acetate, diethylene glycol monomethyl ether, and diethylene glycol monobutyl ether acetate (3) nitrogen-containing compounds such as urea, 2-pyrrolidinone, N-methyl-2-pyrrolidinone, and 1,3-dimethyl-2-imidazolidinone; and (4) sulfur-containing compounds such as 2,2′-thiodiethanol, dimethyl sulfoxide and tetramethylene sulfone. Typical aqueous-based surfactant compositions useful in the invention may contain 2-10 weight percent co-solvent(s).

Particular humectant and co-solvents useful in the present invention are 1,2-alkane diols (e.g. 1,2-hexane diol and 1,2-pentane diol) and lower alkyl glycol ethers (e.g. polyethyleneglycol monobutyl ether and diethyleneglycol monomethyl ether). These compounds are advantageous since surfactants formulated with the inventive polymeric dispersed surfactants can provide increased density and reduced mottle when printed onto plain papers. This is an advantage over surfactant dispersed surfactants or other polymeric dispersed surfactants known in the art since these systems can be destabilized by the high surface activity of the 1,2 alkane diols or alkyl glycol ethers.

The composition generally comprises a surface-treatment agent together with a surfactant compound in water. The solution enables the surface-treatment agent and surfactant compound to combine to render the surface water repellant.

In the composition according to the invention, the amount of surfactant compound is between 0.5 and 5% by weight based on the amount of the surface-treatment agent. The amount of the surface-treatment agent is preferably between 10 and 35% by weight of the final composition. The amount of water in the composition is generally between 5 and 90% by weight.

In a preferred embodiment of the process of the invention, the applied composition contains 2 to 10% by weight of the mixture of the active compounds. This composition is applied in the quantity of 0.05 to 4 liters/m².

Various techniques may be used for applying a coating solution to an infill particle such as casting, spinning, spraying, dipping (immersing), ink jet printing, electrostatic techniques, and combinations of these processes. Choosing an application technique principally depends on the viscosity and surface tension of the solution. In embodiments of the present invention, dipping and spraying are preferred because it makes it easier to control the uniformity of the coating layer.

The synthetic PIP surfacing materials system may further comprise an underground injection, watering or sprinkler system for applying water to the surfacing as needed, one or more thermal probes for determining the temperature of the synthetic surfacing systems, or a combination thereof. The one or more thermal probes may be a thermocouple system in substantial contact with the synthetic PIP surfacing materials system and would allow remote monitoring of the installation.

The surfacing material may further be treated with one or more performance-enhancing additive such as antimicrobial agents, one or more anti-freezing agents, or a combination thereof.

As described herein, it is desirable to have a surface-modifying agent coating the rubber particles of synthetic PIP surfacing materials to provide a source of water for evaporative cooling of the turf surface during hot weather.

In another embodiment, the rubber particles are fabricated so that the surface-modifying agent coating comprises about 0.02% to about 10% by weight of core of granular material. In another embodiment, the surface-modifying agent coating comprises about 0.04% to about 5.0% by weight of the core of granular material. In another embodiment, the coating comprises about 0.06% to about 3.0% by weight of the core of granular material.

In one embodiment, performance-enhancing additive(s) are added to the material. In one embodiment, the performance-enhancing additive(s) are antimicrobials. In one embodiment, the antimicrobial actives are boron containing compounds such as borax pentahydrate, borax decahydrate, boric acid, polyborate, tetraboric acid, sodium metaborate, anhydrous, boron components of polymers, and mixtures thereof.

In one embodiment, the odor absorbing/inhibiting active inhibits the formation of odors. An illustrative material is a water-soluble metal salt such as silver, copper, zinc, iron, and aluminum salts and mixtures thereof. In another embodiment, the metallic salts are zinc chloride, zinc gluconate, zinc lactate, zinc maleate, zinc salicylate, zinc sulfate, zinc ricinoleate, copper chloride, copper gluconate, and mixtures thereof. In another embodiment, the odor control actives include nanoparticles that may be composed of many different materials such as carbon, metals, metal halides or oxides, or other materials. Additional types of odor absorbing/inhibiting actives include cyclodextrin, zeolites, silicas, activated carbon (also known as activated charcoal), acidic, salt-forming materials, and mixtures thereof. Activated alumina (Al₂O₃) has been found to provide odor control comparable and even superior to other odor control additives such as activated carbon, zeolites, and silica gel.

In some aspects, additional additives may optionally be employed with the particulate compositions, including odor-binding substances, such as cyclodextrins, zeolites, inorganic or organic salts, and similar materials: anti-caking additives, flow modification agents, surfactants, viscosity modifiers, and the like. In addition, additives may be employed that perform several roles during modifications. For example, a single additive may be a surfactant, viscosity modifier, and may react to cross-link polymer chains.

In another embodiment, a color altering agent such as a dye, pigmented polymer, metallic paint, bleach, lightener, etc. may be added to vary the color of rubber particles, such as to darken or lighten the color of all or parts of the composition so it is more appealing. In another embodiment, the color-altering agent comprises up to approximately 20% of the infill composition, more preferably, 0.001%-5% of the composition. In another embodiment, the color altering agent comprises approximately 0.001%-0.1% of the composition.

In another embodiment, the carriers for the color-altering agent are zeolites, carbon, charcoal, etc. These substrates can be dyed, painted, coated with powdered colorant, etc.

In another embodiment of the invention, surfacing installed with surface-modifying agent coated rubber particles, which have lost effectiveness for cooling can also be reactivated by introducing additional surface-modifying agent solution. The surface-modifying agent solution can be introduced by spraying or by injecting the surface-modifying agent solution into the top layer of the surfacing.

In an alternative embodiment of the, the synthetic PIP surfacing materials system may further comprise surfacing, which may be comprised of one or more layers. When more than one layer comprises the surfacing, each layer of the surfacing may be of different compositions than other layers.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A method for manufacturing a poured in place surfacing on site, comprising: preparing a substrate for receiving the surfacing; mixing rubber particles with at least one binder to form a surfacing mixture; placing the mixture over the substrate; and allowing the mixture to dry; wherein the dried mixture forms the poured in place surfacing; wherein a coating material is included with the surfacing to substantially modify the surfacing material with water retention or hydrophilic properties.

2. The method of claim 1, wherein the substrate is selected from one or more of bare ground, loose fill, stone, gravel, sand, asphalt, cement, rubber, and construction materials; and one or more surfacing layers substantially adjacent to the topside of the foundation.

3. The method of claim 1, wherein the substrate is a loose fill material selected from a group consisting of rubber mulch, wood chips, shredded tire rubber, pea gravel and loose foam.

4. The method of claim 3, wherein the loose fill material includes only rubber particles without a binder.

5. The method of claim 1, wherein the binder is polyurethane.

6. The method of claim 5, further comprising mixing at least one colorant with the rubber particles and the at least one binder.

7. The method of claim 6, further comprising: after the mixture has dried, incorporating color into an additional mixture of rubber particles and at least one binder; placing this colored mixture over the dried mixture; and then allowing the colored mixture to dry whereby the dried colored mixture provides a colored uppermost surface to the poured in place surfacing.

8. The method of claim 1, wherein the coating material is a topically applied surface treatment agent.

9. The method of claim 1, wherein the surface treatment agent is an aqueous super absorbent polymer (SAP).

10. The method of claim 1, wherein the surface treatment agent cures in situ at ambient temperatures.

11. The method of claim 1, wherein the surface treatment agent is blended with binder before or after being mixed with rubber particles forming a flowable/moldable/extrudable rubber material that can be poured in place.

12. The method of claim 1, wherein a super absorbent polymer (SAP) particulate is introduced into the poured in place surfacing.

13. The method of claim 12, wherein super absorbent polymer (SAP) particulate is generally a ground super absorbent polymer (SAP).

14. The method of claim 12, wherein super absorbent polymer (SAP) particulate is mixed into the poured in place surfacing material and then formed into the finished surfacing.

15. The method of claim 12, wherein the super absorbent polymer (SAP) particulate is introduced into the poured in place surfacing after the surfacing is in place.

16. The method of claim 12, wherein an aqueous absorbent polymer (SAP) is blended with a binder before or after being mixed with rubber particles forming a flowable/moldable/extrudable rubber material that can be poured in place.

17. The method of claim 9, wherein an aqueous super absorbent polymer (SAP) and a surfactant are blended with a binder before or after being mixed with rubber particles forming a flowable/moldable/extrudable rubber material that can be poured in place.

18. The method of claim 1, wherein a particulate super absorbent polymer (SAP) and a surfactant are blended with a binder before or after being mixed with rubber particles forming a flowable/moldable/extrudable rubber material that can be poured in place.

19. The method of claim 1, wherein surfactant is introduced to the surfacing to create a hydrophilic effect on the surface of the rubber enabling moisture retention and evaporative cooling.

20. A poured in place surfacing, comprising: a first rubber-containing layer including rubber particles and at least one binder which has reacted with the rubber to form a poured in place surfacing when dried, wherein a coating material is included with the surfacing to substantially modify the surfacing material with water retention or hydrophilic properties.
